(19) United States
(12) Patent Application Publication
(10) Pub. No.: US 2010/0143549 A1
(43) Pub. Date: Jun. 10, 2010

(54) Apparatus, pods and methods for processing expandable food materials

(76) Inventors: Kevin Hoyt, Sandown, NH (US); Richard DeSalvo, Danvers, MA (US); Alan Soucy, Georgetown, MA (US)

Correspondence Address: GRIMES & BATTERSBY, LLP, 488 MAIN AVENUE, Suite 300, NORWALK, CT, 06851, US

(21) Appl. No.: 12/454,969

(22) Filed: May 26, 2009

Related U.S. Application Data
(63) Continuation-in-part of application No. 11/407,386, filed on Apr. 19, 2006.

(51) Int. Cl. A21C 11/16; A47J 36/00; A23L 1/01; A23P 1/12; A23P 1/14

(52) U.S. Cl. 426/233; 99/324

(57) ABSTRACT

The present invention relates in general to methods and apparatus for processing expandable food materials, and more particularly to methods and apparatus for low shear thermo-mechanical processing of food materials and unique pods for use in connection with such methods and apparatus. The invention can include cooker and extruder apparatus for the customized production of food products, including a compression module, a dryer module, and a control unit, that interact with the pods to produce desired food product.

### CROSS-REFERENCE TO RELATED APPLICATIONS

This continuation-in-part application claims priority to and the benefit of U.S. provisional patent application Ser. No. 60/672,902, filed Apr. 19, 2005, and of U.S. parent application Ser. No. 11/407,386, filed Apr. 19, 2006, the entire disclosure of both of which is hereby expressly incorporated herein by reference. Applicant is also concomitantly filing an additional continuation-in-part application based upon the above-identified common U.S. parent application, and applicant hereby expressly incorporates herein by reference the entire disclosure of such concomitantly filed continuation-in-part application.

### FIELD OF THE INVENTION

The present invention relates generally to methods and apparatus for processing expandable food materials, in particular methods and apparatus for low shear thermo-mechanical processing of food materials. More particularly, the present invention relates to unique, modular pods designed for use with the aforementioned methods and apparatus.

### BACKGROUND OF THE INVENTION

Mass-produced breakfast cereals, some of which use expandable food materials, have several disadvantages, for example, high cost, the inclusion of preservatives and other unwanted ingredients, and a lack of choice of ingredients. A consumer with allergies, for example, is limited to certain selections and types of products. Similar disadvantages exist for other mass-produced food products, such as, for example, snack foods, croutons, bread crumbs, and other types of puffed foods.

Health conscious consumers depend on major commercial food manufacturers to provide freshness and balanced nutrition in their breakfast cereals. Unfortunately, due to the high-shear processes used in producing these cereals and the addition of preservatives for the purpose of increasing shelf life, the health, freshness and nutrition aspects of the food suffer greatly.

This invention provides a method for conveniently producing freshly made highly nutritious, breakfast cereals to the health conscious home consumer by means of a low-shear extrusion process. This invention will further provide a method for conveniently producing freshly made and highly nutritious snack and pet foods, also in the home environment. In the pet food application, the invention provides an improved nutritional value over commercially sold pet food, avoidance of uncontrollable portions experienced with bulk quantity food, and elimination of the need for large bag purchase and storage.

Additional applications of the invention can include, but are not limited to: Pasta Extruder and Crouton Extruder.

Various examples of methods and apparatus for processing food materials can be found in U.S. Pat. No. 2,858,218, U.S. Pat. No. 2,858,219, U.S. Pat. No. 4,187,727, U.S. Pat. No. 4,465,452, U.S. Pat. No. 4,317,842, U.S. Pat. No. 4,503,127, U.S. Pat. No. 4,517,204, U.S. Pat. No. 4,537,786, U.S. Pat. No. 4,547,376, U.S. Pat. No. 4,608,264, U.S. Pat. No. 4,615,894, U.S. Pat. No. 4,756,916, U.S. Pat. No. 4,820,470, U.S. Pat. No. 6,511,309, U.S. Pat. No. 5,198,239, U.S. Pat. No. 4,569,848, U.S. Pat. No. 4,276,800, U.S. Pat. No. 4,405,298, U.S. Pat. No. 4,801,258, U.S. Pat. No. 4,859.165, U.S. Pat. No. 5,773,043, U.S. Pat. No. 4,555,407, U.S. Pat. No. 5,577,410, U.S. Pat. No. 4,778,365, U.S. Pat. No. 4,460,611, U.S. Pat. No. 4,548,571, U.S. Pat. No. 4,528,900, U.S. Pat. No. 4,578,027, U.S. Pat. No. 4,648,821, U.S. Pat. No. 4,656,039, U.S. Pat. No. 4,698,000, U.S. Pat. No. 4,715,803, U.S. Pat. No. 4,743,458, U.S. Pat. No. 4,882,185, U.S. Pat. No. 4,882,172, U.S. Pat. No. 4,469,475, U.S. Pat. No. 4,372,734, U.S. Pat. No. 5,403,603, U.S. Pat. No. 4,251,201, U.S. Pat. No. 5,333,538, U.S. Pat. No. 4,406,603, U.S. Pat. No. 5,993,188, U.S. Pat. No. 4,268,532, U.S. Pat. No. 4,900,572, U.S. Pat. No. 4,966,542, U.S. Pat. No. 4,456,446, U.S. Pat. No. 4,659, 580, U.S. Pat. No. 5,198,257, U.S. Pat. No. 5,449,281, U.S. Pat. No. 4,886,441, U.S. Pat. No. 4,999,206, U.S. Pat. No. 4,685,877, U.S. Pat. No. 6,764,701, U.S. Pat. No. 5,464,642, U.S. Pat. No. 5,304,055, and U.S. Pat. No. 6,120,360, the disclosures of which are hereby incorporated by reference in their entirety.

Apparatus for processing expandable food materials typically utilize screw-type extruders that can impart excess shear on the food material, thereby degrading the food material and the finished product. Some of the methods and apparatus used for processing food materials can negatively impact the taste and texture of the finished product. For example, shear can degrade starch molecules forming dextrin, an undesirable by-product, and degrading product quality. Additionally, shear is also responsible for substantial wear of screws and barrels, thereby shortening the life of the equipment.

In prior art devices, food ingredients are continuously fed into a process chamber which often incorporates a continuously spinning auger, upwards of 100 feet long. The auger mixes the ingredients, generates heat and pressure within the chamber and advances the mixed food material towards the discharge nozzle at the end of the chamber. Differential between the interior chamber pressure and the exterior chamber pressure (atmospheric) causes the mixed/heated food material to discharge through the nozzle. As the food material exits the nozzle, it expands and is cut to desired lengths by means of rotating blades. Expansion occurs as a result of flashing (instant boiling) of most of the water content within the food material upon exposure to atmospheric pressure outside of the process chamber. Expansion rate is controlled by regulating the moisture and starch percentages of the food material prior to exit through the nozzle. After the discharged food material is cut, it is transported to a baking chamber where it is dried to a moisture content of approximately 8 percent. The drying process in combination with added chemical preservatives prevents bacterial growth, thereby, increasing shelf life of the final food product.

The heat required for the prior art processes is generated as a result of friction developed between the auger and the food material. In addition, some of the food material is ground between the auger and chamber wall. These actions cause high shear within the food material, thereby destroying a large percentage of its nutrient and starch contents.

Chemical preservatives are added to the food product, making that product capable of being stored in warehouses and on store shelves for prolonged periods of time. Given the choice, today's health conscious consumers prefer food products that are freshly made and free of chemical preservatives.

Also prior art pet food products are either supplied in pre-cooked condition, whether in bulk or individually packaged portions, or in raw food condition, only available through niche markets and at a more expensive price point. Consumers have thus sometimes been compelled to substitute human food for their pets to achieve the desired nutritional value and freshness.

The prior art cited during the prosecution of the parent application does not disclose the invention covered by the instant patent application:
Wenger et al. U.S. Pat. No. 6,340,487—The Wenger '487 patent discloses:
   (i) a commercial, high-capacity extrusion system for handling mass quantities of material (e.g., discussing a “40-ton run” and “short production runs of up to about 10,000 pounds”);
   (ii) that subjects material to intense heat, pressure and shear and maintains the same continuously during operation by means of a special die assembly, upstream pre-conditioner and feed bin assembly.
Volk, Jr. U.S. Pat. No. 4,882,105—The Volk '105 patent discloses:
   (i) an extruder in which intense pressure and temperatures (i.e., pressure of 350 psi and temperature elevated above 400 degrees Fahrenheit) are achieved for cooking the product and providing an expanded or puffed effect after the product is released through the die into the lower atmospheric pressure;
   (ii) having an automatic control with a temperature sensor for monitoring the exit temperature of the extrudate and several pressure transducers which monitor the pressure within the extruder to insure that the desired temperature, moisture, pressure and shear are achieved.
Hauck et al. U.S. Pat. No. 6,773,739—The Hauck '739 patent discloses:
   (i) an extruder that subjects material to increased levels of heat, superatmospheric pressure and shear in order to at least partially cook the material and form an extrudate;
   (ii) having an adjustable back pressure valve assembly that permits adjustment of the mechanics of the extruder to maintain elevated heat, pressure and shear.
Johnson U.S. Pat. No. 5,238,385—The Johnson '385 patent discloses:
   (i) an extrusion die assembly attached to the end of an extruder;
   (ii) having the ability to affect post cooking “treatment” of the extruded material.
Huber et al. U.S. Pat. No. 6,422,135—The Huber '135 patent discloses:
   (i) an industrial, large-scale, production extruder apparatus that makes it possible to produce a pre-gelled starch product as well as normally sticky extrudates with minimal or no surfactant.
   (ii) (ii) a dehydration assembly having an agitator, coupled with a drying tower, for drying the extrudate after it emerges from the die assembly of an industrial extruder.
Wenger et al. U.S. Pat. No. 6,482,453—The Wenger '453 patent discloses:
   (i) an extruder system that makes it possible to change the profile (section) of the extrudate quickly to save time in change-over from one profile to another.
   (ii) an up-stream pre-conditioner for uncooked raw food material and a down-stream cascade-type dryer assembly for extrudate.
Hauck U.S. Pat. No. 4,752,139—The Hauck '139 patent discloses:
   (i) a pre-conditioning device for the preparation of differing types of starch raw material to be processed in a large scale industrial extruder.
   (ii) A device made up of two laterally intersecting cylinders of differing internal diameter containing rotating mixing vanes that process the raw material for product to be manufactured by an extrusion production system on an industrial basis.

The elements disclosed by the instant patent application and for which patent protection is being sought, that are neither disclosed by nor rendered obvious in view of prior art, are unique pods for a home kitchen appliance designed and sized for use on a kitchen counter or in a pet feeding area, for conveniently producing single and/or multiple servings of nutritious, freshly made food products. The pods are used in an appliance that performs the processes of mixing, baking and extruding grain based ingredients in a form that provides a nutritionally sound food, in individual serving sized portions.

The food ingredients used for producing food products in accordance with the present invention are purchased separately as a pre-formulated and pre-mixed batch that is sealed inside a pod constructed with an integrated extrusion nozzle. In the pet food application, pods are formulated and sized according to specific daily nutrition requirements of end use animals, which is beneficial to portion control and weight management.

The appliance utilized with the unique pods is designed to perform the process of food preparation in a few minutes, utilizing a combination of pre-mixed ingredients in the pod with no preservatives or artificial ingredients. The process permits a “no muss, no fuss” production and clean up.

Other novel features that are disclosed include:
1. longer useful life of the apparatus due to less wear on extruder screws and barrels from low shear;
2. reduced degrading of food material;
3. less degradation of starch molecules and formation of undesirable dextrin by-product;
4. on demand manufacture of ready to eat (RTE) breakfast cereal;
5. tailored selection of finished product taste and texture;
6. individual choice of and flexibility regarding ingredients;
7. avoidance of the inclusion of preservatives and other unwanted ingredients;
8. ingredient content control to address allergy issues;
9. economical cost per batch of the finished product; and
10. elimination of “overhead costs” of commercial cereal manufacturers.

### SUMMARY OF THE INVENTION

The invention generally relates to a low shear food cooker/extruder for the customized production of breakfast foods (such as cereals) and similar food products. In one embodiment, the invention relates to a counter-top breakfast cereal apparatus targeted for the consumer (home use) market. The cooker/extruder can be used to freshly produce ready to eat (RTE) breakfast cereal for the consumer. The cereal would be made on demand and, if preferred, preservative-free, with ingredients tailored to particular taste and texture preferences. Some of the advantages of a apparatus and related processes in accordance with the invention are that batches are made fresh and on demand; preservatives are not required in the recipes; cost per batch is economical, whereas, overhead costs passed on by commercial cereal manufacturers are eliminated; consumers with allergies to specific food materials control ingredient content of their recipes; and better overall output quality due to minimized starch damage within the final food product.

In another embodiment, the invention relates to a compact pet food production apparatus targeted for the consumer (home use) market that can be placed in the customary pet food feeding area.

In one aspect, the invention relates to a very low shear cooker/extruder utilizing a piston to extrude the expandable food material. In one embodiment, the piston can include a rotating mechanism to introduce a minimum amount of shear as may be necessary to aid the cooking of the food product, but not enough to damage the food product. Additionally, the cooking can be performed under pressure as high as about 500 psi. A variety of dies or nozzles can be used with the extruder to produce different finished products and to accommodate different viscosity food products.

Generally, the cooker/extruder apparatus includes three basic modules: a compression module, a dryer module, and a control unit. The apparatus is capable of cooking, forming and puffing a food product, such as, for example, cereals, snack foods, breadsticks, croutons, pet foods, and textured vegetable proteins, without the use of oil, hot air or gun-puffing, for example, to puff the product. Additionally the apparatus could be used to produce non-puffed foods, such as pellets or other half-product made for later processing by other means, e.g., frying. Furthermore, the apparatus could also be used as an analytical test machine to measure properties, for example, viscosity of materials. The apparatus can vary in size and configuration to suit specific applications. For example, a relatively small manually operated unit could be produced as a home appliance. A larger version could be manufactured for in-store production, such as might be found in supermarket bakeries or health-food stores. A larger and more sophisticated automated machine may also be produced.

In one embodiment, the compression module includes a chamber for inserting and processing raw food materials, a quick-release sealed chamber cover for maintaining high pressure during the cooking/extrusion process, a heating element that surrounds the chamber, a variable speed piston for ejecting processed food materials from the chamber, a piston drive mechanism, and an adjustable pressure-activated nozzle for controlling the expansion rate of food materials ejected from the chamber. The piston drive mechanism could be mechanically (e.g., a screw), electrically, hydraulically, or pneumatically driven.

The dryer module, in one embodiment, includes a variable speed blade for cutting extruded/expanded food material to desired lengths, a bin for capturing and containing said food material, a heater for drying and toasting said food material, a blower for circulating said food material during the drying/toasting process, and an enclosure that houses the blade, bin, heater and blower.

In one embodiment, the control unit includes electro/mechanical hardware and circuitry, which controls all electrical, mechanical, and physical aspects of the cooking, extrusion, drying and toasting processes. All of the necessary hardware and circuitry is housed inside a grounded enclosure.

In another aspect, the invention relates to methods of producing food products with low or very low shear. The methods involve thermo-mechanically processing the food products. The methods include introducing a raw or partially processed food product into a compression module, heating and/or pressurizing the food product to cook the product, and extruding the product under minimal shear.

In another aspect, the invention relates to a food product as produced by a method in accordance with one embodiment of the invention, such as, for example, cereal or a puffed cheese snack. The methods and apparatus of the invention can be carried out with a variety of raw ingredients to suit a particular user's tastes. For example, pre-stressed or pre-gelatanized ingredients could be used, such as melted starches. The apparatus can include additional modules for modifying the extruded food product, for example for flavoring or combining with other food products.

In another aspect, the invention relates to a self-actuating poppet valve. The poppet valve is used in the compression module to trigger the extrusion process. In one embodiment, the valve is a pressure-actuated poppet valve that connects the chamber to the die or nozzle when a pre-determined pressure is reached within the chamber.

In yet another aspect of the invention, each batch of ingredients is sealed in a pod that has a moisture percentage that is low enough to prevent bacterial growth and rancidity during pod storage. If the finished food product requires fat, e.g., for nutritional value, or if it requires flavorings or seasonings, these can be stored in a reservoir in the pod or outside the pod. The pod is placed in the compression module of the apparatus for processing.

In yet another aspect of the invention, individual pods can have an attached bar code that contains processing parameters unique to the intended finished food product in the particular pod and which bar code is read by the appliance's control system at the beginning of the process in order to convey the requisite processing parameters to the compression module and drying module of the appliance.

In yet another aspect of the invention, the pod contains premixed dry ingredients and water is introduced into the premixed dry ingredients, either from a water blister within the pod that is mechanically burst or pierced, or from a water reservoir outside of the pod.

In yet another aspect of the invention, the dry ingredients and water are mixed within the pod by a combination of timed vibration at controlled frequencies and mechanical manipulation, or by heating the water and resultant steam migration.

In yet another aspect of the invention, the pod is pressurized while the food mixture is heated, and then the pressure is increased and the pod nozzle is opened and the food material is extruded out the nozzle, causing the food material to expand as a result of flashing (instant boiling) of most of the water content within the food material upon exposure to atmospheric pressure outside of the pod nozzle, before it is cut into desired sizes.

In yet another aspect of the invention, once the food ingredients within the pod have been processed by the appliance and the food material has been extruded from the pod, the pod is simply removed from the appliance and discarded.

The invention is unique in that:
a. The invention has its process parameters (pressure and temperature) being applied to the food material as opposed to being produced by the food material, making the process highly efficient in ingredient consumption (cost), nutrient provision, control and repeatability.
b. The food produced by this invention requires no preservatives. It is made fast, fresh, on demand and ready to eat.
c. The heat required for this process is generated external to, and is conducted into, the food material. Nutrient levels are maintained because the food material remains static throughout the heating phase, generating zero friction and zero shear.
d. Food material is subjected to low shear only as it passes through specially engineered geometry within the pod nozzle. This low shear assists in expanding the food material, while causing minimal to zero damage to its nutrients and starch content. Dogs and cats prefer foods having undamaged starch and, quite often, will refuse to eat foods having damaged starch.
e. Because the food produced by this invention is “ready to eat” and requires no final packaging:
   i. If demand dictates, specific pods could be formulated with natural preservatives to allow for delayed consumption of the finished food product while maintaining its nutritional value.
   ii. The food does not require post-process drying. Furthermore, since moist foods are highly palatable to dogs and cats, pet food pods could be formulated for high post-extrusion moisture content.
f. With the exception of the cutting blades, the appliance does not require cleaning between pod insertions. Food materials make contact with the pod and its integrated nozzle and the cutting blades only. The pod with its integrated nozzle is disposable and possibly biodegradable and can be discarded. Alternative embodiments integrate the cutters into the pod nozzle, making cleaning of the appliance optional but unnecessary.
g. Pods can be continuously processed for fast production of multiple servings of multiple food types. The user only needs to remove the latest spent pod, insert an unprocessed pod and press start.

These and other objects, along with advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic side view of a compression module for an apparatus for processing expandable food materials, in accordance with one embodiment of the invention;

FIG. 2A is a schematic perspective view of the compression module of FIG. 1;

FIG. 2B is a second schematic perspective view of the compression module of FIG. 1;

FIG. 2C is a third schematic perspective view of the compression module of FIG. 1;

FIG. 2D is a fourth schematic perspective view of the compression module of FIG. 1;

FIG. 3 is an exploded schematic perspective view of the compression module of FIG. 1;

FIG. 4 is a table of parts for the compression module of FIGS. 1-3;

FIG. 5A is a schematic perspective view of a dryer module for an apparatus for processing expandable food materials, in accordance with one embodiment of the invention;

FIG. 5B is a second schematic perspective view of the dryer module of FIG. 5A;

FIG. 6A-6I are schematic perspective views of the dryer module of FIG. 5A, in various stages of construction;

FIG. 7 is a table of parts for the dryer module of FIGS. 5A-6I;

FIG. 8 is a schematic view of a control unit for an apparatus for processing expandable food materials, in accordance with one embodiment of the invention;

FIG. 9 is a schematic view of three positions descriptions for the toggle switch of FIG. 8;

FIGS. 10A-10F are schematic views of a housing and valve for a self-actuating die and poppet valve combination, in accordance with one embodiment of the invention;

FIG. 11 is a schematic view of a piston and valve for a self-actuating die and poppet valve combination, in accordance with one embodiment of the invention; and

FIG. 12 is a schematic view of a spacer and spring for a self-actuating die and poppet valve combination, in accordance with one embodiment of the invention.

FIGS. 13a and 13b are two views of a preferred embodiment of a pod constructed in accordance with this invention, namely, a multi-piece pod construction with an internal water blister and an integrated flexible extrusion nozzle.

FIGS. 14a, 14b and 14c are three views of an alternative embodiment of a pod constructed in accordance with this invention, namely, a multi-piece pod construction with an internal water pouch, an internal fat pouch and an integrated rigid extrusion nozzle.

FIGS. 15a, 15b and 15c are three views of an alternative embodiment of a pod constructed in accordance with this invention, namely, a multi-piece pod construction with a single supply of dry food ingredients in an annular ring chamber, a single water pouch, multiple fat pouches and multiple extrusion nozzles.

FIGS. 16a and 16b are two views of an alternative embodiment of pods constructed in accordance with this invention, namely, a multi-piece pod construction with a single supply of dry food ingredients in an annular ring chamber, an integrated extrusion nozzle and a compression plate for forcing processed food material through the extrusion nozzle. In the embodiment shown in FIG. 16a, the required water is injected into the pod by the appliance during processing. In the embodiment shown in FIG. 16b, the required water is in the pod, sealed between two compression plates.

FIGS. 17a and 17b are two views of an alternative embodiment of a pod constructed in accordance with this invention, namely, a multi-piece, pod with a flexible side wall construction, separate dry food ingredient and water pouches and an integrated extrusion nozzle.

FIGS. 18a and 18b are two views of an alternative embodiment of a pod constructed in accordance with this invention, namely, a multi-piece pod, with a semi-rigid side wall construction, separate dry food ingredient and water pouches and an integrated extrusion nozzle. FIG. 18b shows multiple pods that are connected and can be advanced through the appliance for processing at different times.

FIGS. 19a and 19b are two views of an alternative embodiment of a pod constructed in accordance with this invention, namely, a multi-piece pod, with a rigid side wall construction, with a dry food ingredient chamber into which water is injected by the appliance during processing, an extrusion nozzle and a compression plate for forcing processed food material through the extrusion nozzle.

FIG. 20 is a graph which displays net power versus time.

FIG. 21 is a graph which displays pressure rise versus time.

FIG. 22 a graph which displays center temperature versus time.

FIG. 23 a graph which displays center temperature versus time in a dimensionless format.

### DETAILED DESCRIPTION

Embodiments of the present invention are described below. It is, however, expressly noted that the present invention is not limited to these embodiments, but rather the intention is that all equivalents and all modifications that are apparent to a person skilled in the art are also included. In particular, the present invention is not intended to be limited to any specific food material or end product, or (unless expressly stated otherwise) to any specific pod shape or pod material.

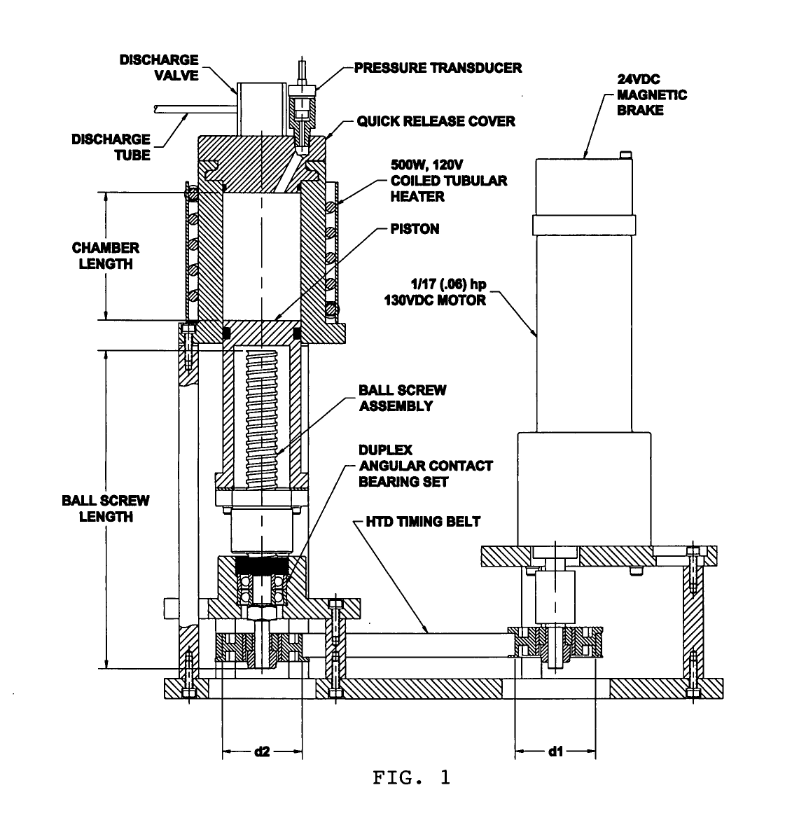

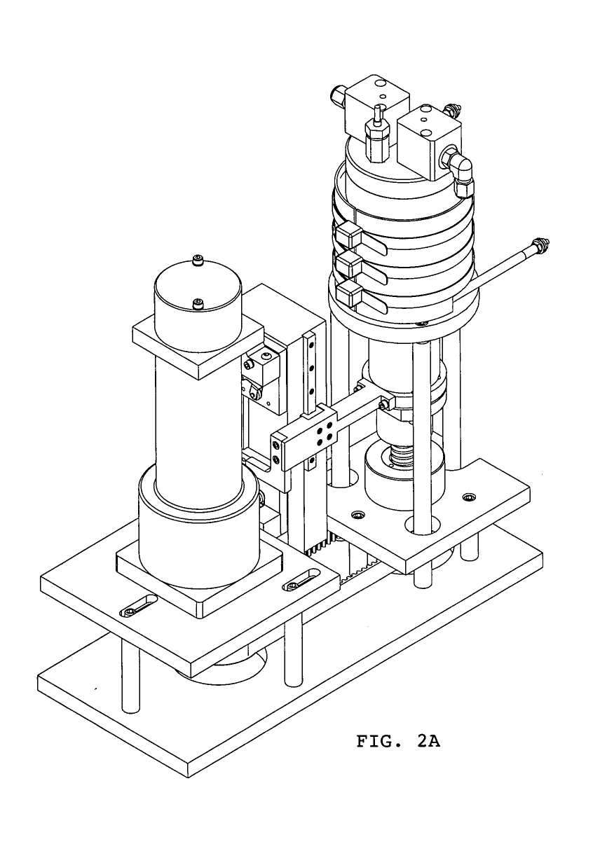

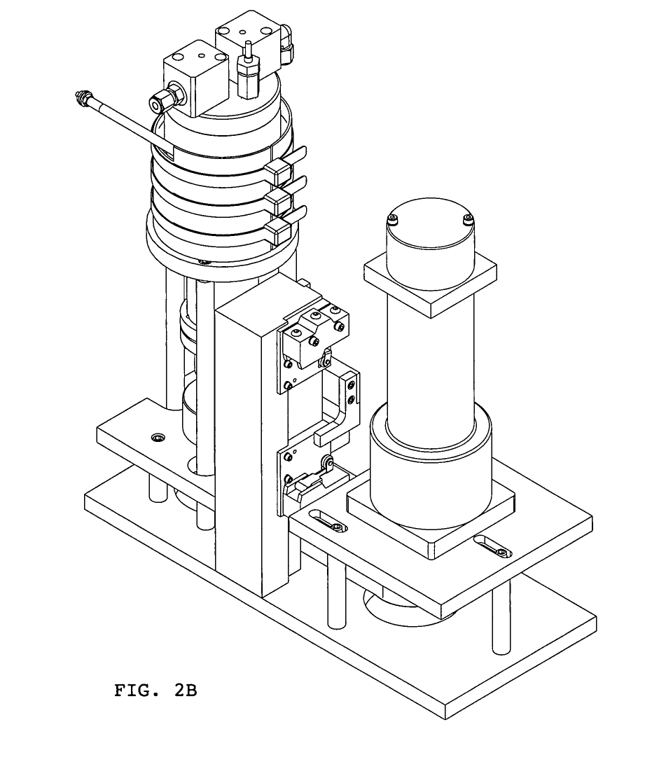

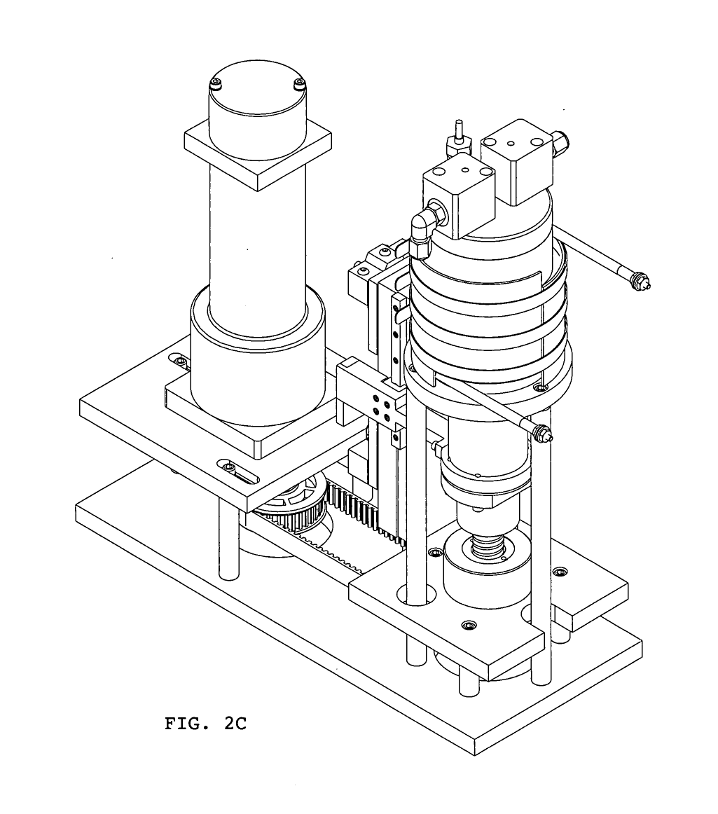

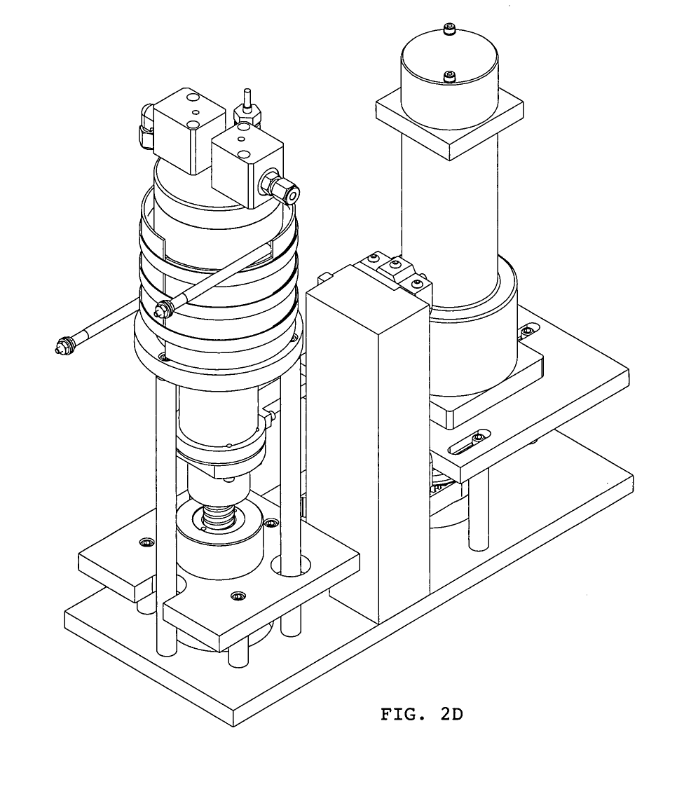

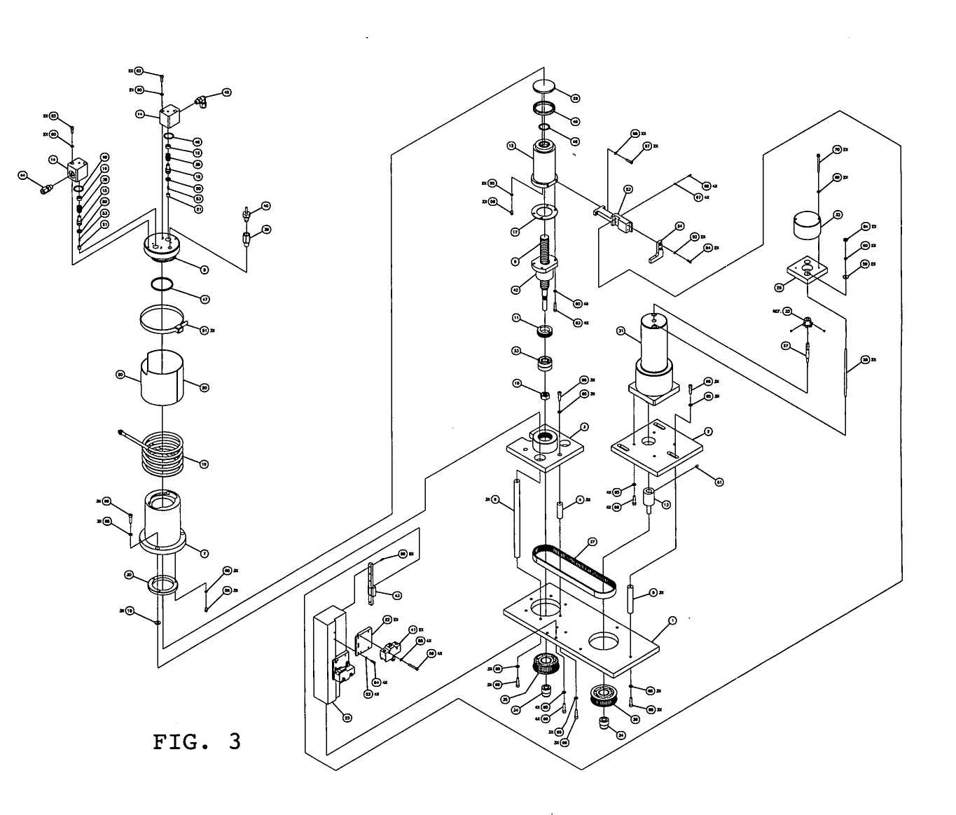

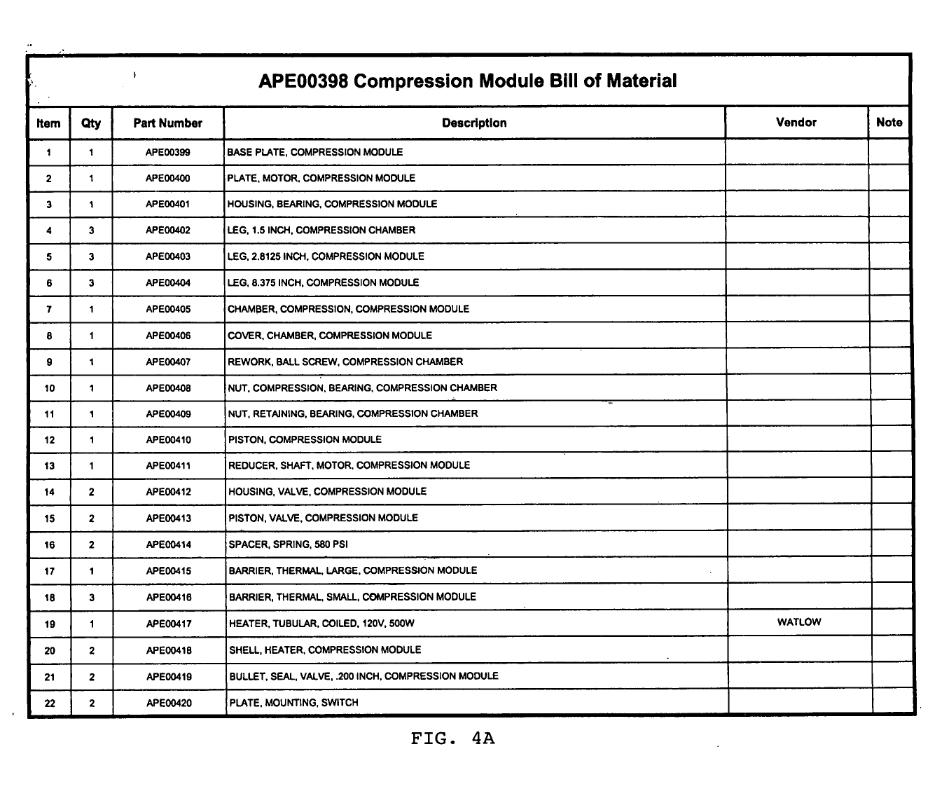

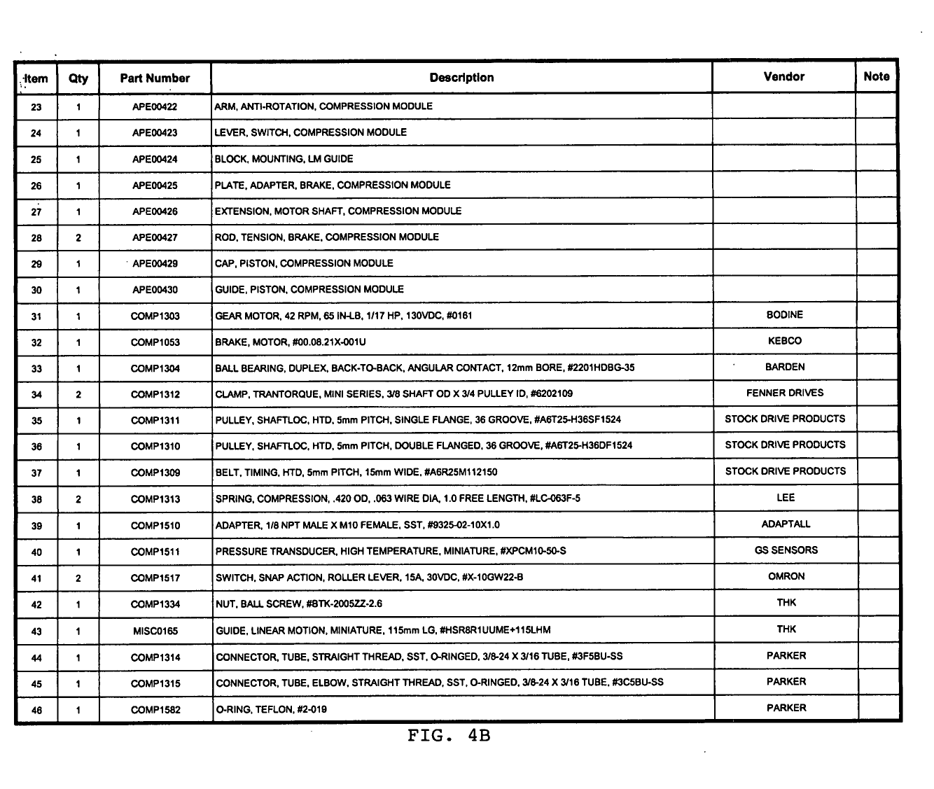

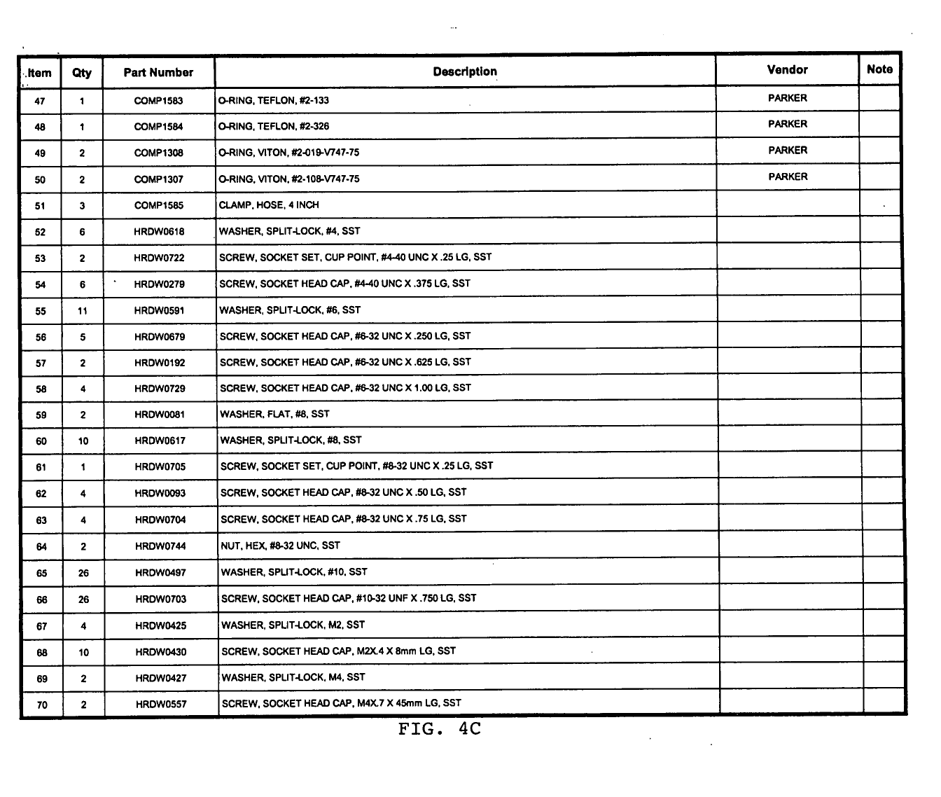

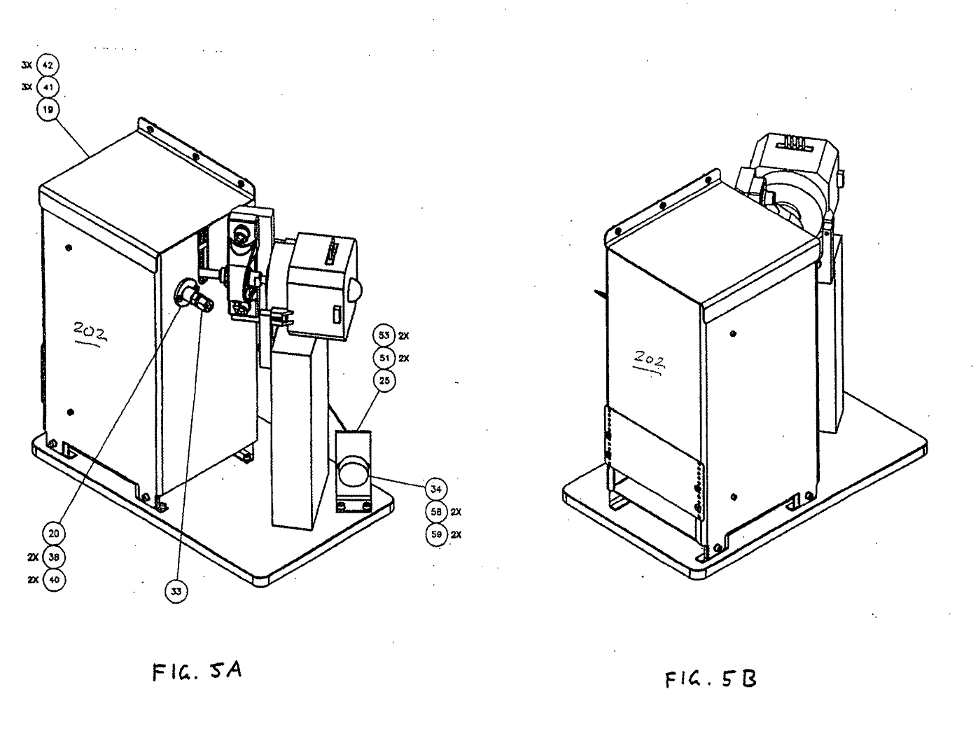

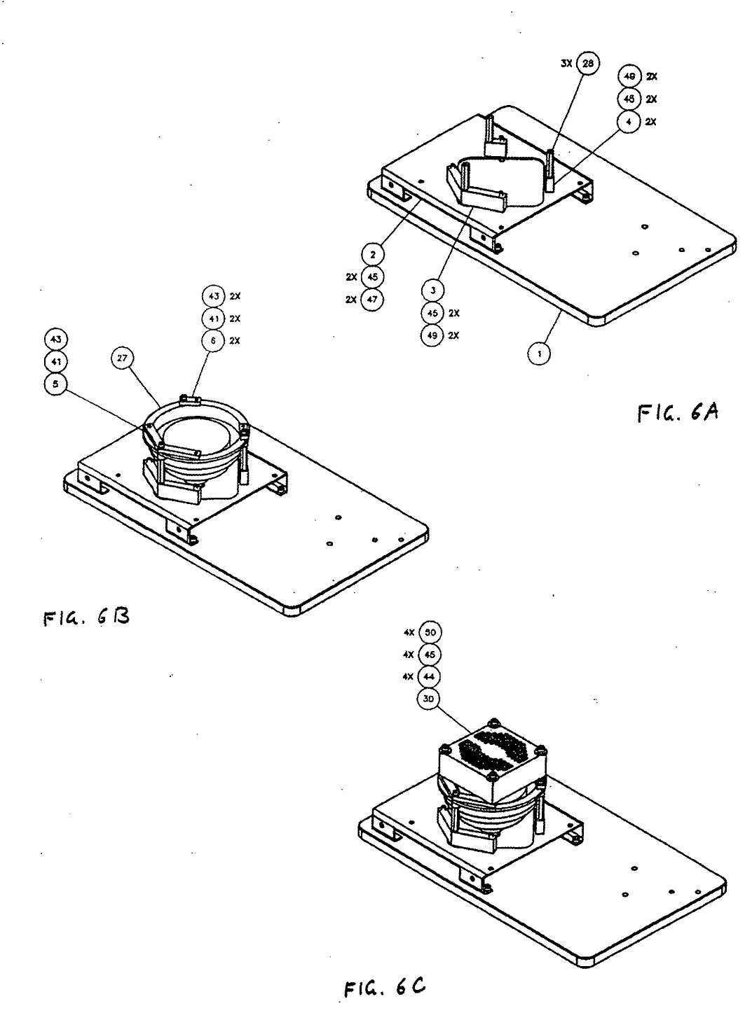

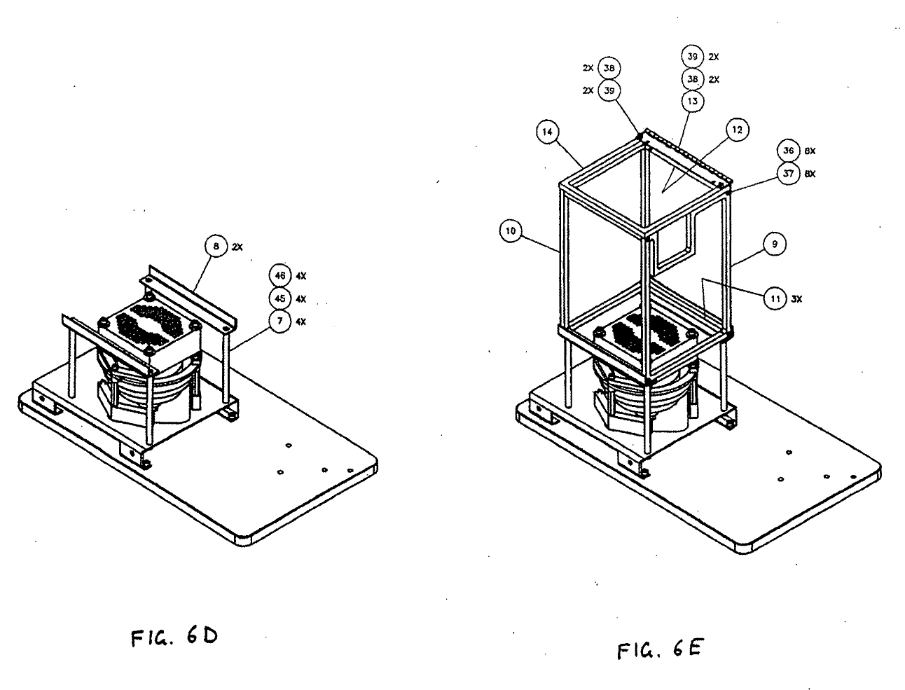

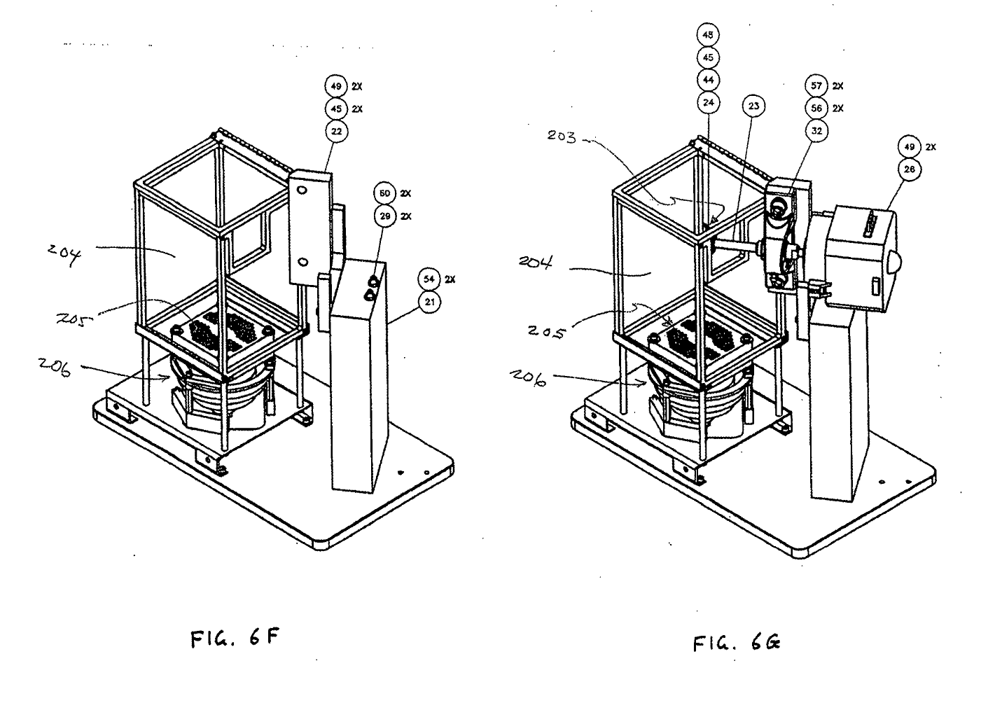

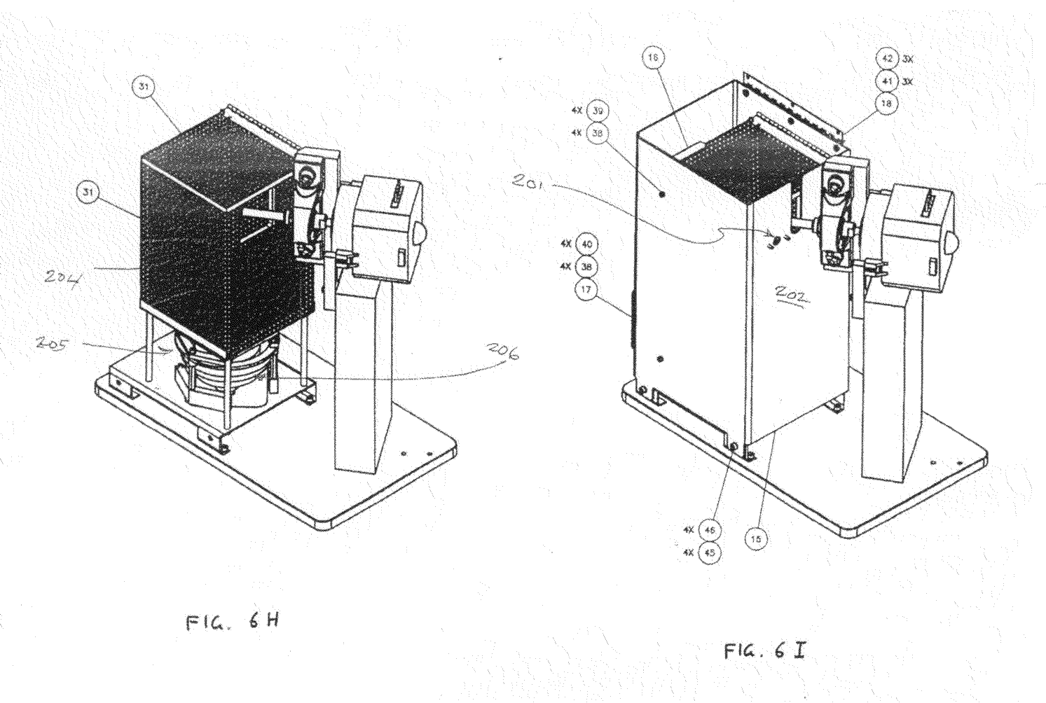

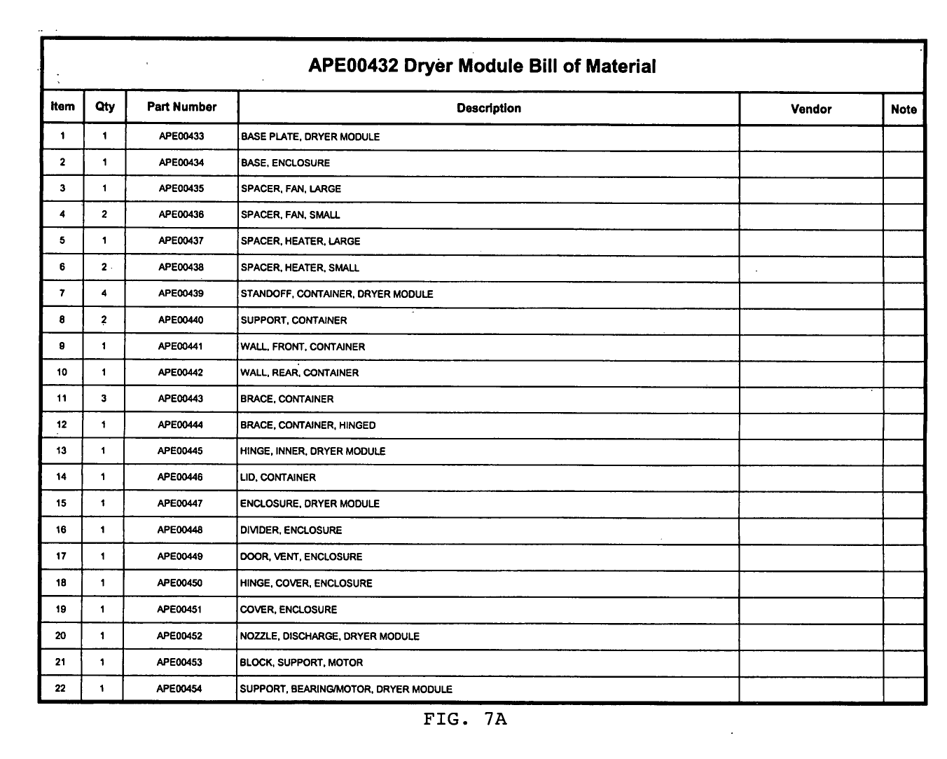

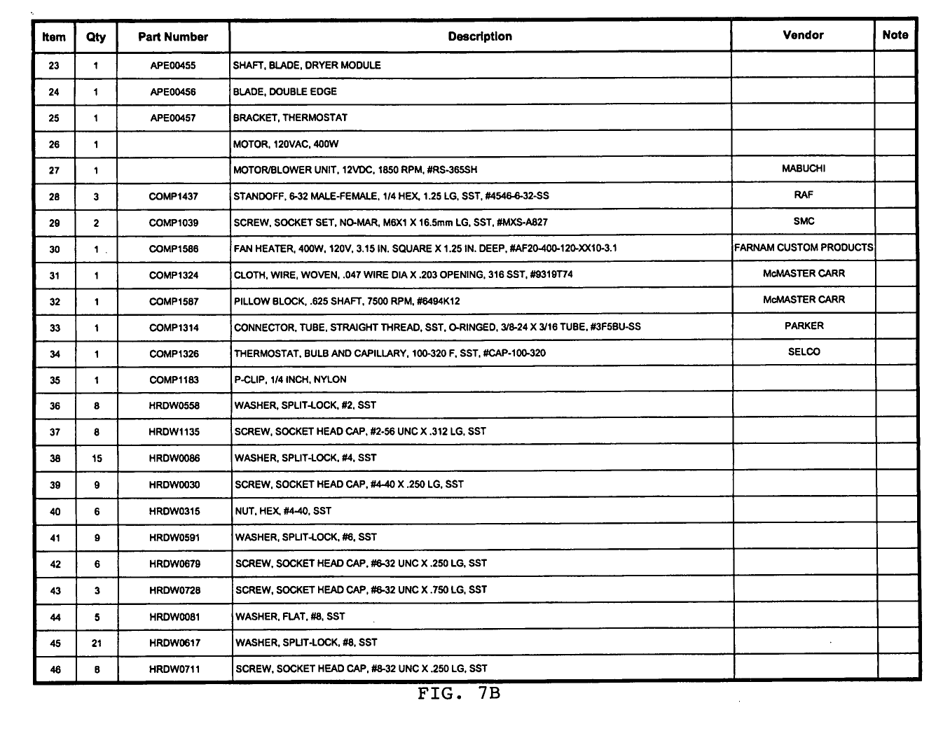

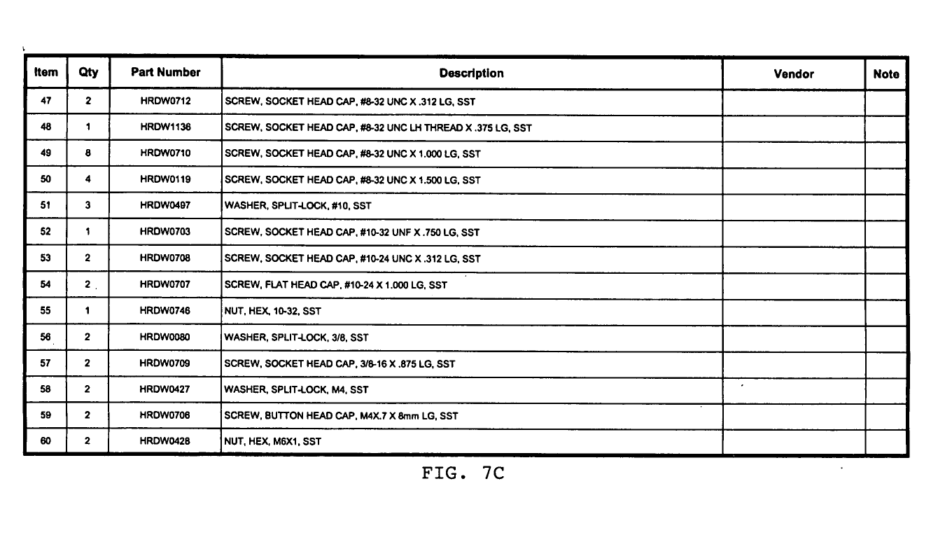

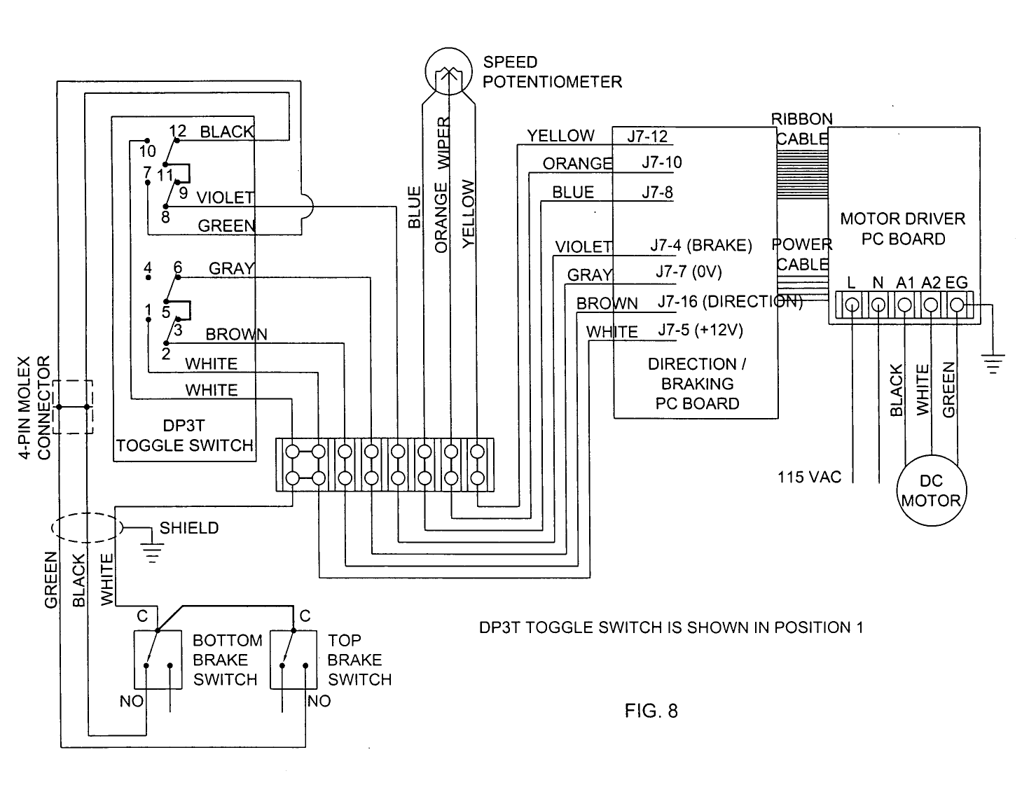

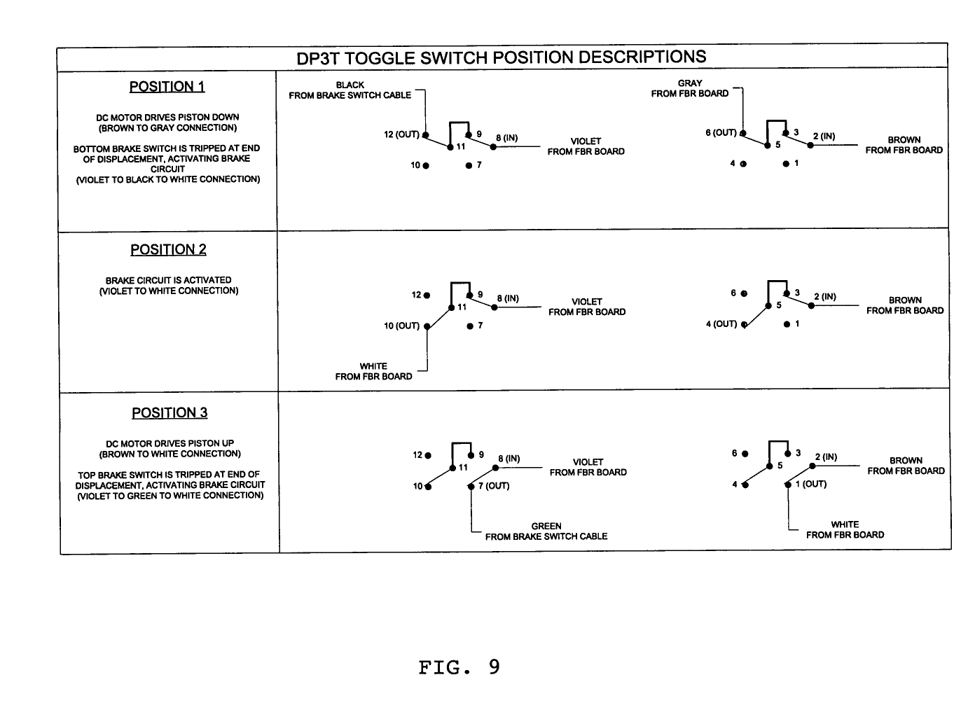

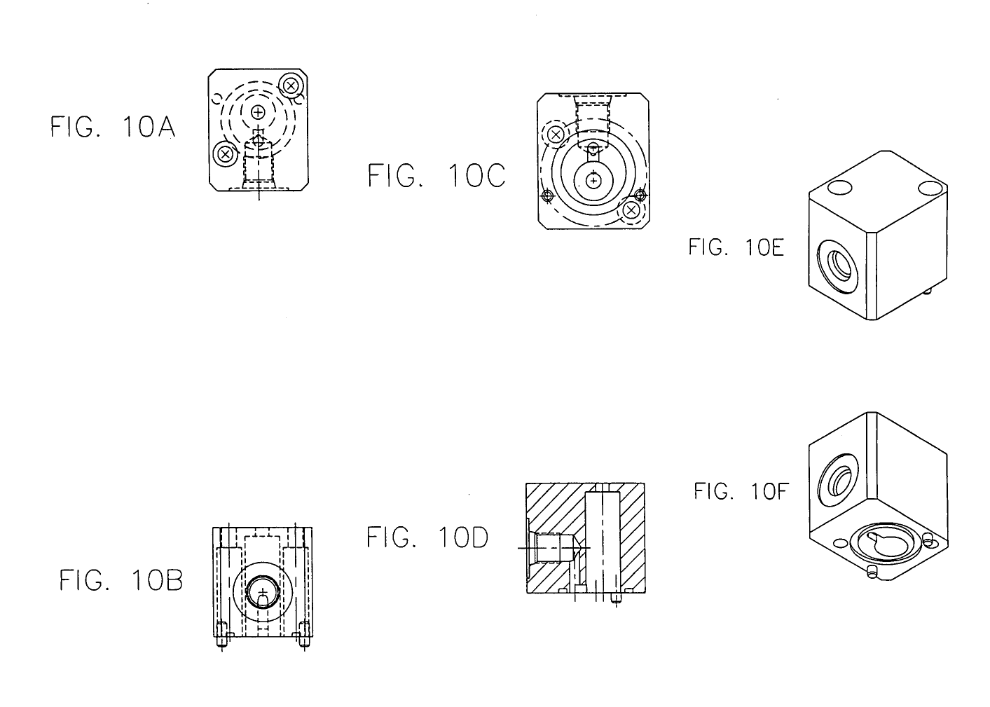

The compression module includes the components listed and arranged as shown in FIGS. 1-4. FIGS. 8 and 9 show an electrical schematic representing one embodiment of a control unit for operating the apparatus. The dryer module includes the components listed and arranged as shown in FIGS. 5A-7. The operation of the various modules and components are described hereinbelow.

The invention also relates to a variety of methods of producing food products. Generally, the operation of the apparatus includes the following steps. Food materials of a particular recipe are inserted into the chamber 101 of the compression module 100 and the chamber cover 102 is attached and sealed to the chamber and locked. The heating element 103 is activated to begin the cooking process. As the closed-volume cooking process proceeds, the pressure and boiling point of the food materials continuously elevates above their atmospheric levels, and the starches within the food material transform to a plasticized state. After a specified elapsed cooking time (dependant on recipe and ingredient quantities, for example), the heating element is deactivated to terminate the cooking process. The piston 104 is then activated to begin the extrusion process by decreasing the volume of the chamber and, thereby, further increasing the differential pressure between the food materials within the chamber and atmospheric pressure outside of the chamber.

Once the pressure of the food materials within the chamber reaches a pre-determined level, the nozzle or valve 105 opens, allowing the pressurized food material to flow from the chamber out the discharge tube 106. The piston remains in motion until all food materials within the chamber have been ejected. Approximately ninety five percent of the water content within the food material instantaneously boils upon exit from the nozzle, causing the ejected food material to expand. Expansion rate is dependent upon original water content of the recipe and is controlled by multiple mechanical parameters, such as nozzle orifice size and piston speed. At ejection, the plasticized starches throughout the food material go through a glass transition, that is, they form cellular structures that cool rapidly to maintain the size, shape and texture of the expanded food product.

The expanded food product flowing from the compression module nozzle 105 out the discharge tube 106 optionally enters the dryer module 200 through an opening 201 in the enclosure wall 202 thereof. After exiting from this opening, the food product is cut into equal length sections by a spinning blade 203. Section length is selected based on the desired size and/or shape of the finished food product. Section length is determined by the speed of the blade 203. Depending on the type of food product produced, the dryer module may not be needed as the product can be air dried and manually cut or otherwise manipulated. Additionally, other processes can be carried out to sweeten, flavor, color, texturize, enrich, and otherwise treat the finished food product.

After being cut, the food sections are gravity fed into a perforated holding bin 204. Once the complete batch of food product has been sectioned and is in the holding bin 204, a heater 205 and a blower unit 206 are both activated. In one embodiment, the heater 205 is located directly beneath the holding bin 204 and has an output of approximately 400 watts and is toggled on and off by a thermostat control. The heater's function is to toast the food product for added flavor and decrease its moisture content to, for example, between about three percent and about five percent. The desired resultant moisture content will depend on the food product being produced. In one embodiment, the blower unit 206 is located directly beneath the heater 205, has an output of approximately 20 cfm, and remains on throughout the drying/toasting process. The blower's function is to promote even heating and to prevent burning of the food product by circulating the food sections within the bin 204 during the drying/toasting process.

The size of the apparatus and the size and arrangement of the various components of the apparatus will be selected to suit a particular application. In one embodiment, a cylinder 101 having a diameter from about 0.25″ to about 4″ is used. The piston 104 stroke can be from about 0.5″ to about 18″. The apparatus can be scaled up or down to suit the particular application, for example as a home appliance or for an industrial application. For example, in the compression module 100, the cylinder 101 size and quantity will be selected based on the amount of product to be produced, the heat transfer requirements, and the desired cycle time. For example, better heat transfer permits the use of raw feeds and higher temperatures that will allow operation at reduced moistures for better product quality.

One of the considerations when selecting the size of the cylinder 101 is the time required to achieve a desired level of heat penetration, which is approximately proportional to the square of the cylinder's diameter. For example, if it takes one hour to heat a 2″ cylinder, we expect the same results in 15 minutes with a 1″ diameter cylinder. And, using the same piston 104 stroke, the production rate will remain constant. Each shot will have ¼ of the original quantity, but will happen four times more frequently. Moreover, multiple cylinders (like in a reciprocating engine) can be used to increase the product output. A description of thermal penetration can be found in Heldman and Singh, Food Process Engineering, pp. 124-130, the disclosure of which is hereby incorporated by reference in its entirety.

In another embodiment, an annular piston can be used. Although a more complex design, converting from a circular cross-section to an annular cross-section vastly increases the heat transfer area (heating inside and outside the annulus) with a dramatic decrease in cycle time and improvement in product uniformity. For example, replacing the solid 2″ piston with a hollow 3″ piston would require an inner diameter of 2.24″ for the same volume with the same stroke. But the heat transfer area would increase by a factor of about 2.6, and the relative distance that the heat would have to penetrate would be only about 38% of that in the 2″ piston. A one-hour heating cycle could be reduced to about 8.8 minutes with this design. With that reduced cycle time, the production rate would increase about 6 times.

In one embodiment, the cylinder head is insulated to, for example, minimize condensation at the cold spot in the center of the product and the loss of heat to the atmosphere. Additionally, the cylinder wall thickness can be varied to alter the heat transfer properties. The material of the cylinder can be, for example, stainless steel, an aluminum/stainless sandwich (as used in waterless cookware), or normal mild steel with a stainless liner.

The apparatus of the present invention is an improvement over the prior art at least because of its lack of shear until the product enters the final die orifice, which is an inherently high-shear operation required to create the desired product characteristics. Shear earlier in the process (for example in the screw of a standard extruder where it is responsible for generating most of the heat required to cook and puff the product) does little to build texture, and can be detrimental to product quality by damaging, or dextrinizing, the starch molecules. The present invention utilizes external methods of heating, such as conduction heating, thereby eliminating the damaging shear.

The size of the die should be selected to optimize discharge speed, but will also vary depending on the raw materials used and the food product to be produced. There is an optimum extrusion flow rate for any particular die size. For larger product size, requiring a larger die hole, the piston speed can be increased. The die orifice itself can be streamlined for better product formation.

Moisture is another operating parameter that affects the final food product produced. In one example, the mix used in the test was formulated to be at 25%, which is higher than normally used for expanded products. After mixing for about 1 hour, the moisture was measured by loss-of-weight in a microwave oven to be about 17%, which is about ideal for standard corn-based snack extrusion.

The following test data is included to be illustrative only.

### I. Power Input and Shell Temperature:

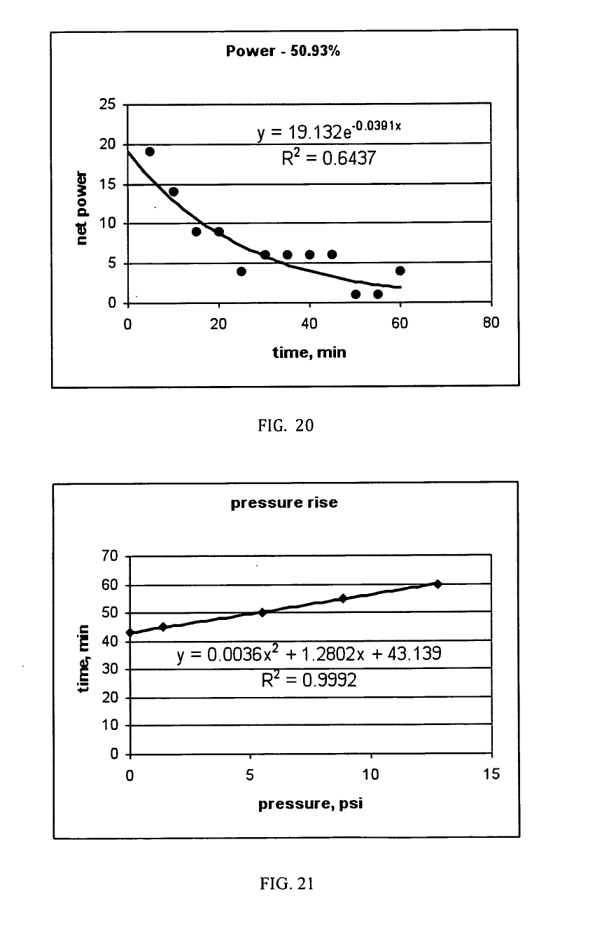

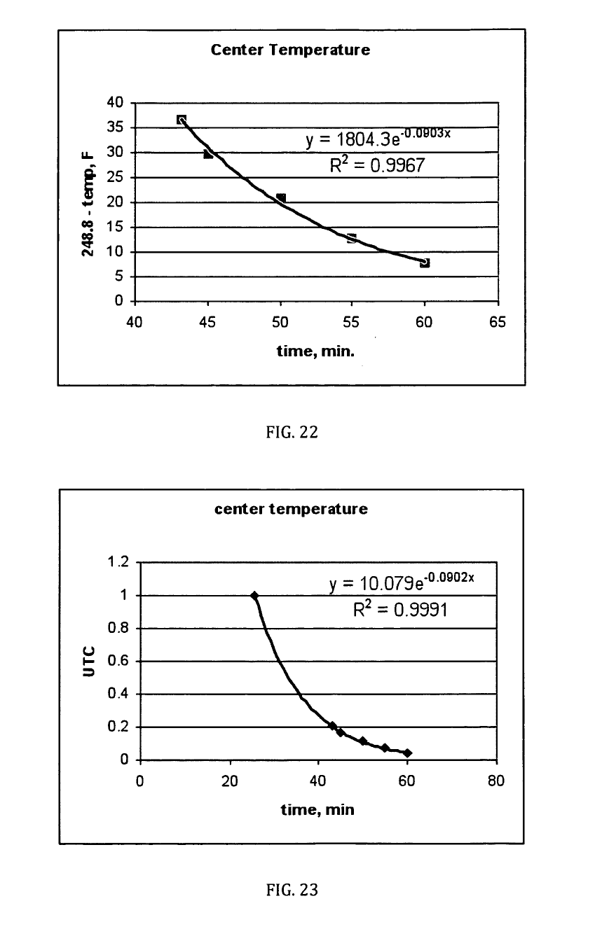

Referring now to FIG. 20, a graph is shown displaying net power versus time. In one test, the power to the electrical heater was adjusted to maintain an average shell temperature of about 453 deg. F., starting with an initial power setting of about 100% and dropping as the sample heated up to avoid overheating the outer surface of the product within the cylinder. Applying an exponential model, a final power setting of about 51% is expected at equilibrium. Assuming that the potentiometer setting is proportional to the actual power delivered, about half of the total coil power at that temperature is lost to the atmosphere.

### II. Heat Penetration—Pressure and Product Temperature:

Referring now to FIGS. 21 & 22. Moisture migrates from the outer portions of the cylinder to the center due to the temperature gradient. The center portion remains cool for a period of time required for the heat to diffuse inward, and then its temperature starts to rise, eventually coming to equilibrium with the outer portion. This picture is complicated somewhat by the head space above the product which allows the moisture to move quickly to those cooler portions, and the effect of the unheated cylinder head which prevents that top-center portion from coming to equilibrium. Some of the energy loss noted above would be through the head.
Center Temperature Estimation: It was assumed that the temperature at the top center was that which would be in equilibrium with the pressure measured in the head space (steam, created by the hot outer portion, would condense in the center at a temperature in equilibrium with the pressure).
Equilibrium Temperature: Using the exponential model, an equilibrium final temperature for the top center position was estimated at about 249 deg. F., considerably lower than the shell temperature, and much lower than the normal temperature range usually required for good expansion. An additional point on this curve was generated by extrapolating the pressure curve backward in time to zero pressure (one atmosphere absolute) where the temperature would be about 212 deg. F. This occurred at about 43 minutes.

Dimensionless Format: Referring now to FIG. 23. Unsteady-state heat transfer data are usually converted into dimensionless form for analysis. Knowing the initial and final temperature, the conversion is:

$$U T C = \frac{{T}_{f} - T}{{T}_{f} - {T}_{i}}$$

where: Tᵢ=initial temperature
T_{f}=final temperature
UTC=unaccomplished temperature change

UTC goes from 1 to zero at infinite time.

Penetration Time: The resulting curve fit the exponential model well, and was extrapolated back to UTC=1 for an initial temperature of about 70 deg. F. That occurred at about 25.6 minutes, which is about how long it took for the first heat to penetrate to the center of the cylinder.

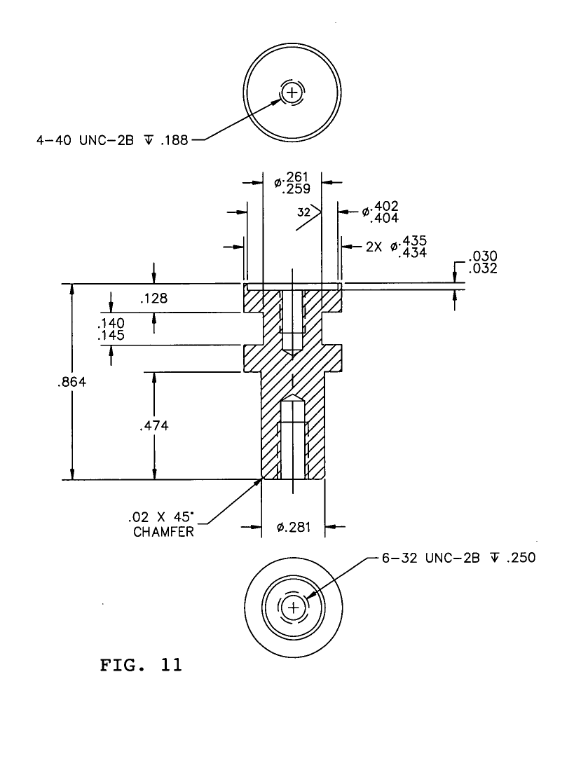

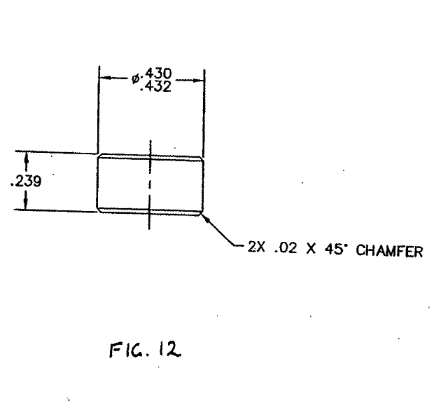

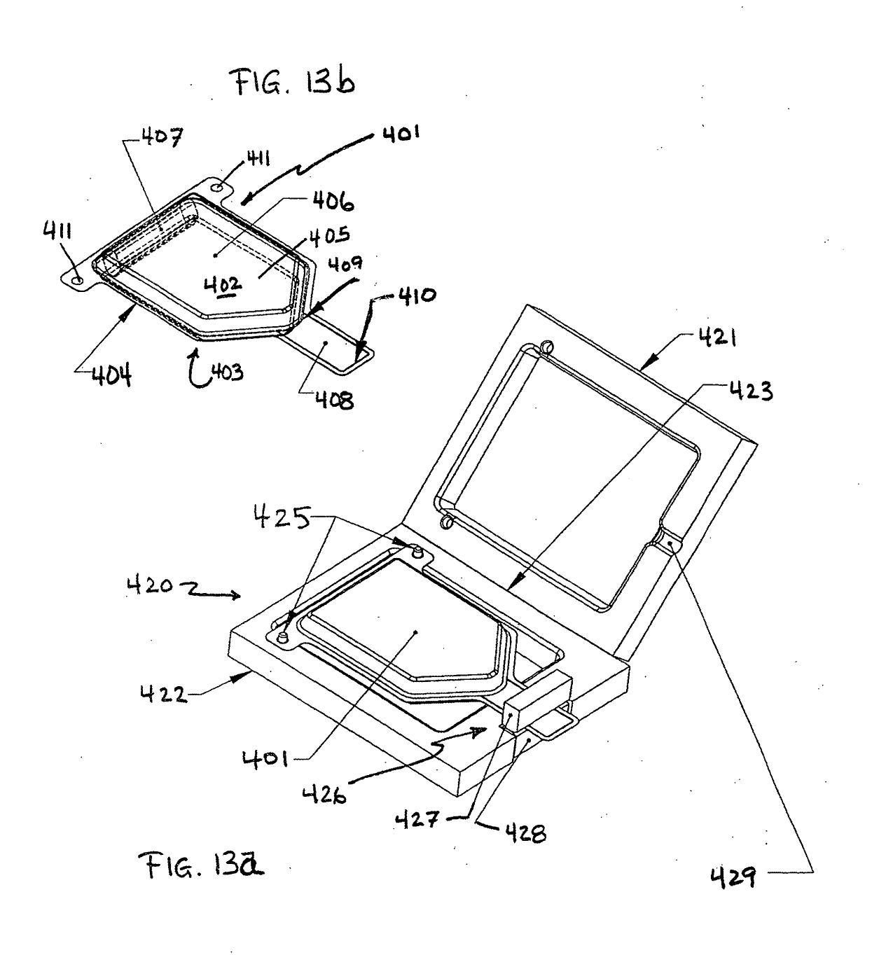

Various embodiments of pods that fall within the scope of this invention are shown in FIGS. 13 through 19. These pods can be utilized to store and deliver food materials of a particular recipe to the chamber 101 of the compression module 100 for processing as hereinabove described.

The preferred embodiment pod 401, disclosed in FIGS. 13a and 13b, is a multi-piece construction with a single integrated nozzle. The pod side wall material can be made from flexible thermoplastic material or flexible aluminum composite foil, or any other similar material that is, to the extent necessary, FDA approved. The pod is intended to make a single serving. The pod includes an upper side wall 402 and lower side wall 403 that are seamed together by heat seals 404 to form an internal chamber 405. The internal chamber 405 includes a dry ingredient pouch 406 and a water blister 407 that is designed to burst at specific process pressure, allowing water to flow into the dry ingredient pouch 406. The pod 401 includes a flexible pod nozzle 408 that is seamed at both ends 409 and 410 to keep pre-processed food and foreign matter out of the nozzle area. The pod includes alignment holes 411 which are used to position the pod within a processing appliance of the type previously disclosed. The processing appliance includes a chamber 420 for receiving the pod 401, comprised of a chamber top half 421 and a chamber bottom half 422, joined by a chamber hinge 423. Accurate placement of the pod 401 within the chamber 420 is assured by the chamber alignment pins 425. The pod alignment holes 410 seat on the chamber alignment pins 425. The chamber clamp 426, comprised of upper and lower members 427 and 428, respectively, holds the pod nozzle 408 closed to keep the food material from exiting during processing. At extrusion pressure the clamp 426 opens, the nozzle seams burst and food is extruded through the pod nozzle 408. Under the extrusion pressure, the flexible pod nozzle forms to the specially engineered geometry of the exit channel 429 in the chamber side walls 421 and 422. In FIG. 13a, the portion of the exit channel 429 in the side wall 421 is shown. The mating portion of the exit channel in the side wall 422 is not shown, as it is hidden beneath the pod 401 loaded in the chamber 420. The geometry of the exit channel promotes the low shearing and optimum expansion/texture of the extruding food product.

An alternate embodiment pod 501, disclosed in FIGS. 14a, 14b and 14c, is a multi-piece construction with a single integrated nozzle. The pod side wall material can be made from rigid and flexible thermoplastic material or aluminum alloy, or any other similar material that is, to the extent necessary, FDA approved. The pod is intended to make a single serving. The pod includes a cylindrical side wall 502 that is closed at either ends 503 and 504 to form an internal chamber 505. The side wall 502 is structurally reinforced by the appliance chamber wall during processing. The internal chamber 505 includes a dry ingredient chamber 506 and a water pouch 507 that is designed to burst at a specific pressure, allowing the water to flow into the dry ingredients. The pod 501 includes a rigid pod nozzle 508 that is sealed by a food burst disk 509 that is designed to burst at extrusion pressure, allowing processed food to extrude through the nozzle, with its specially engineered geometry for low shearing and optimum expansion/texturing of the extruded food product. The pod 501 further includes a sealed compression plate 510 that forces processed food material through the extrusion nozzle 508 under appliance generated pressure. The pod 501 further includes an internal fat pouch 511 sealed by a fat burst ring 512 which is designed to burst at extrusion pressure, allowing fat to flow through the fat discharge channels 513 and dispense onto the extruding food material. The force of the compression plate 510 on the food material within the chamber 505 applies force to the fat pouch and forces the fat out the discharge channels 513.

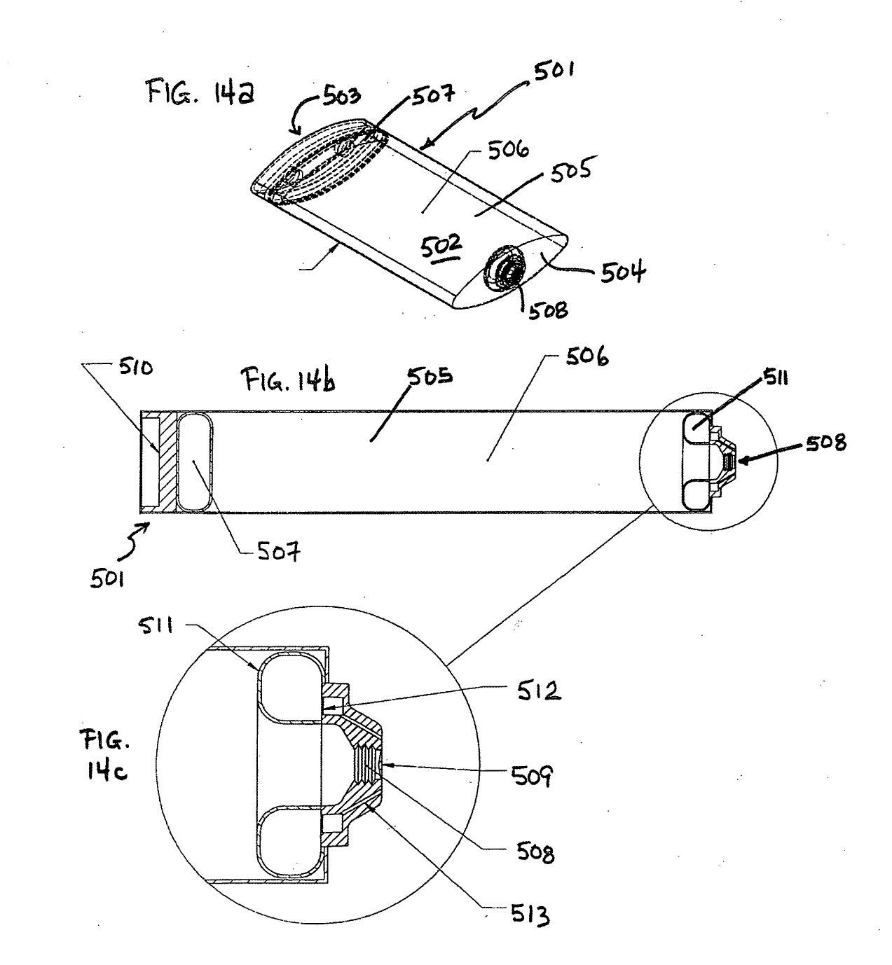

An alternate embodiment pod 601, disclosed in FIGS. 15a, 15b and 15c, is a multi-piece construction with multiple integrated nozzles. The pod side wall material can be made from rigid and flexible thermoplastic material or aluminum alloy, or any other similar material that is, to the extent necessary, FDA approved. The pod is intended to make a single serving. The pod includes a cylindrical side wall 602 that has an annular closure 603 at one end and a full closure 604 at the other end to form an annular internal chamber 605. The side wall 602 is structurally reinforced by the appliance chamber wall during processing and the internal wall 605a is structurally reinforced by the internal heater shell during processing. The internal chamber 605 includes an annular dry ingredient chamber 606. A water pouch 607 is provided within the annular chamber 606 and such water pouch 607 is designed to burst at a specific pressure, allowing the water to flow into the dry ingredients. The pod 601 includes multiple rigid pod nozzles 608 that are sealed by food burst disks 609 that are designed to burst at extrusion pressure, allowing processed food to simultaneously extrude through the nozzles, with their specially engineered geometry for low shearing and optimum expansion/texturing of the extruded food product. The pod 601 further includes a compression plate 610, sealed with 0-rings 610a, that forces processed food material through the extrusion nozzles 608 under appliance generated pressure. The pod 601 further includes internal fat pouches 611, each sealed by a fat burst ring 612 which is designed to burst at extrusion pressure, allowing fat to flow through the fat discharge channels 613 and dispense onto the extruding food material. The force of the compression plate 610 on the food material within the annular chamber 606 applies force to the fat pouches 611 and forces the fat out through the discharge channels 613.

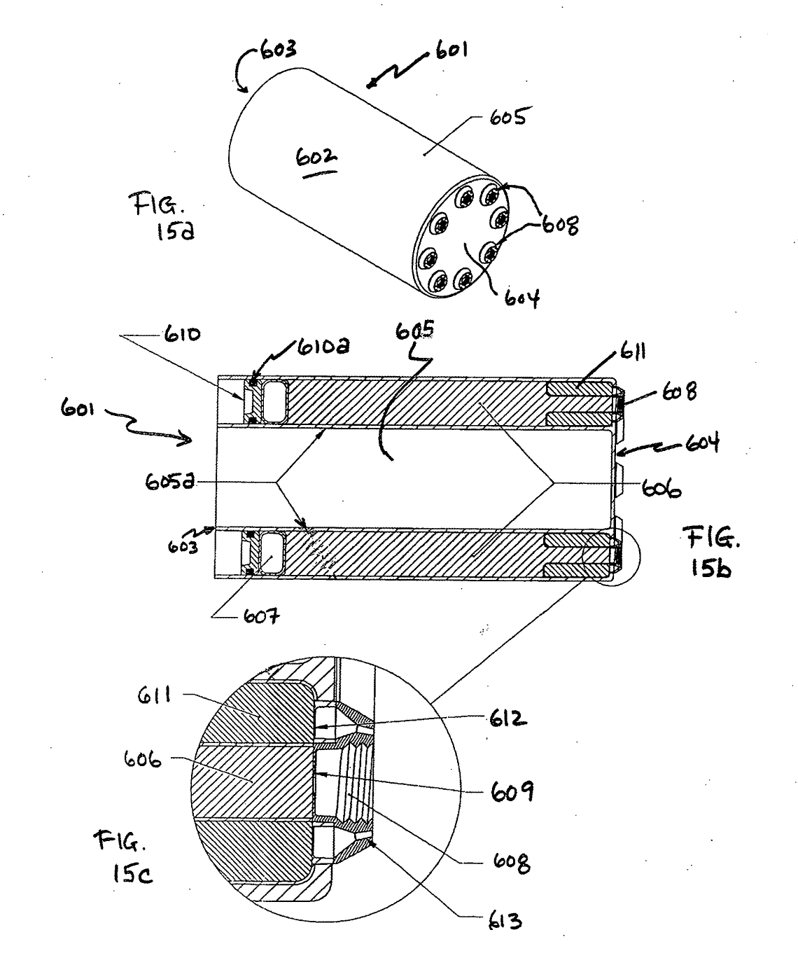

An alternate embodiment pod 701, disclosed in FIGS. 16a and 15b, is a multi-piece construction with a single integrated nozzle. The pod side wall material can be made from rigid or semi-rigid thermoplastic material, the pod compression plate can be made from rigid thermoplastic material and the seal can be made from an aluminum composite, or any other similar material that is, to the extent necessary, FDA approved. The pod is intended to make a single serving. The pod includes a cylindrical side wall 702 that has an annular closure 703 at one end and a full closure 704 at the other end to form an annular internal chamber 705. The side wall 702 is structurally reinforced by the appliance chamber wall during processing and the internal wall 705a is structurally reinforced by the internal heater shell during processing. The internal chamber 705 includes an annular dry ingredient chamber 706. In one optional construction shown in FIG. 16a, water is injected into the annular ingredient chamber 706 in chamber 705 by the appliance through an opening 707a. In an optional construction shown in FIG. 16b, water is present in the pod in a water chamber 707b formed between two sealed compression plates 707c and 707d, and introduced into the annular ingredient chamber 706 within chamber 705 via a water burst disk 707e in the compression plate 707d that is designed to burst at specific process pressure, allowing water from chamber 707b to flow into the dry ingredients in chamber 706. The pod 701 includes a rigid pod nozzle 708 that is sealed by food burst disk 709 that is designed to burst at extrusion pressure, allowing processed food to extrude through the nozzle, with its specially engineered geometry for low shearing and optimum expansion/texturing of the extruded food product. The pod 701 further includes a compression plate, 710 in the optional construction shown in FIGS. 16a and 707c in the optional construction shown in FIG. 16b, that is sealed with 0-rings, 710a in FIGS. 16a and 707f in FIG. 16b, that forces processed food material through the extrusion nozzle 708 under appliance generated pressure. The user removes an adhesive-backed freshness seal 720 prior to loading the pod 701 into the appliance. The pod 701 does not include an internal fat pouch, but rather, fat is sprayed onto the extruded food material by the appliance after exiting the nozzle 708.

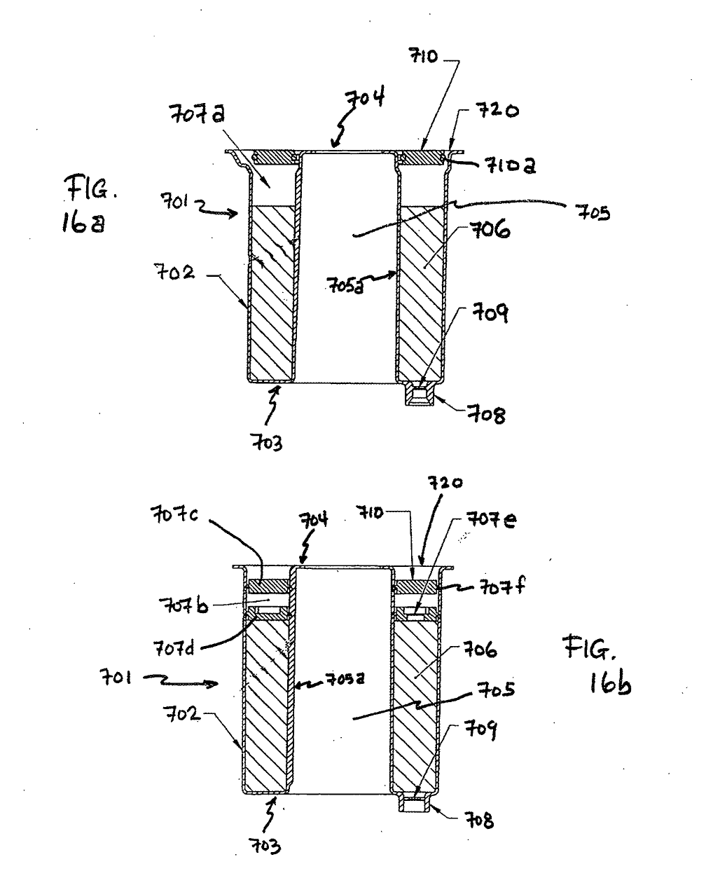

The alternate embodiment pod 801, disclosed in FIGS. 17a and 17b, is a multi-piece construction with a single integrated nozzle. The pod side wall material can be made from flexible thermoplastic material or flexible aluminum composite foil, or any other similar material that is, to the extent necessary, FDA approved. The pod is intended to make a single serving. The pod includes an upper side wall 802 and lower side wall 803 that are seamed together by heat sealed seams 804 to form a first internal chamber 805a and a second internal chamber 805b. The internal chamber 805a includes a dry ingredient pouch or blister 806 and the second internal chamber 805b includes a second water pouch or blister 807. The two pouches or blisters 806 and 807 are separated prior to processing, by an optional heat sealed seam 807a, an optional clip 807b, or both. The clip 807b is removed by the user prior to loading the pod 801 into the appliance to allow the water and dry ingredients to mix. Alternatively, the seal 807a keeps the water and dry ingredients separated until a specific process pressure causes the seal to burst. The pod 801 includes a rigid pod nozzle 808 that is sealed by food burst disk 809 that is designed to burst at extrusion pressure, allowing processed food to extrude through the nozzle 808, with its specially engineered geometry for low shearing and optimum expansion/texturing of the extruded food product. The pod 801 does not include an internal fat pouch, but rather, fat is sprayed onto the extruded food material by the appliance after exiting the nozzle 808.

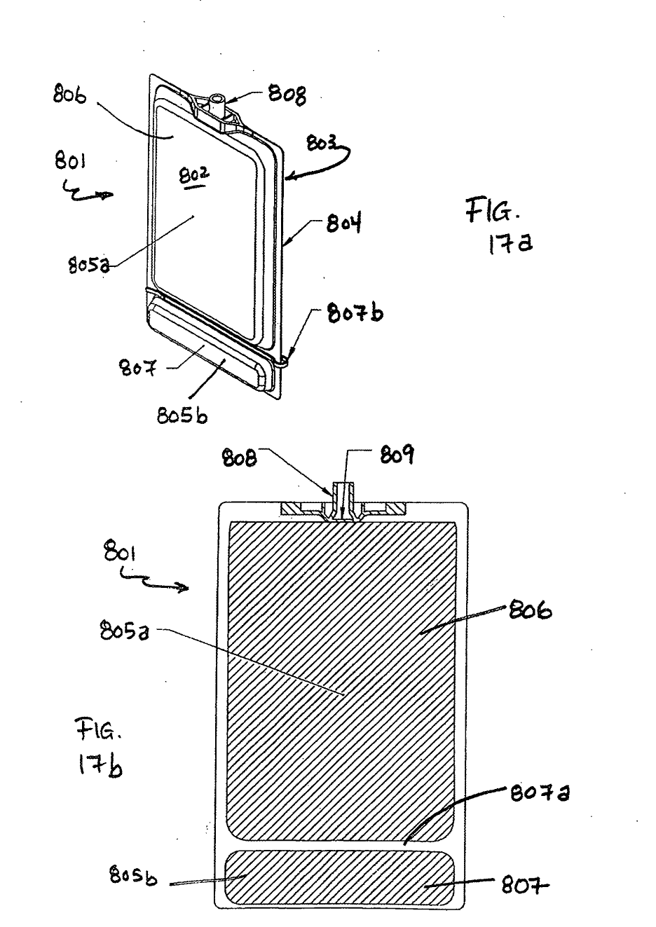

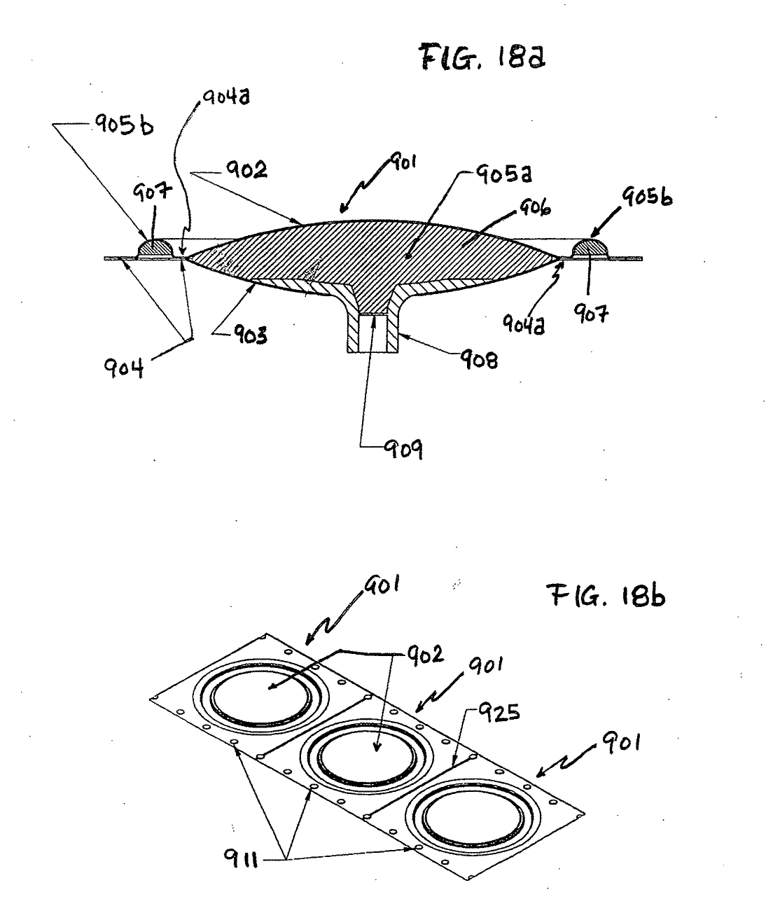

The alternate embodiment pod 901, disclosed in FIGS. 18a and 18b, is a multi-piece construction with a single integrated nozzle. The pod side wall material can be made from semi-rigid thermoplastic material, or any other similar material that is, to the extent necessary, FDA approved. The pod is intended to make a single serving. The pod includes an upper side wall 902 and lower side wall 903 that are seamed together by heat sealed seams 904 to form a first internal chamber 905a and a second internal annular chamber 905b. The internal chamber 905a includes a dry ingredient pouch or blister 906 and the second internal annular chamber 905b includes a second water pouch or blister 907. The two pouches or blisters 906 and 907 are separated prior to processing by a heat sealed seam 904a. The seal 904a keeps the water and dry ingredients separated until a specific process pressure causes the seal to burst, allowing the water to flow from the water pouch 907 into the dry ingredient pouch 906. The pod 901 includes a rigid pod nozzle 908 that is sealed by food burst disk 909 that is designed to burst at extrusion pressure, allowing processed food to extrude through the nozzle 908, with its specially engineered geometry for low shearing and optimum expansion/texturing of the extruded food product. The pod 901 does not include an internal fat pouch, but rather, fat is sprayed onto the extruded food material by the appliance after exiting the nozzle 908. In the optional construction shown in FIG. 18b, a series of pods 901 are connected together and include alignment holes 911 that can interact with pins in the appliance that engage the alignment holes to insure proper seating of the pods 901 within the appliance and advancement of the pods 901 through the appliance. This optional construction allows, in the pet food application. a user to feed an animal in even increments, determined by its weight. For example, a single pod 901 could be designed to have the daily nourishment requirement for a 20 lb dog, and two pods 901 could be processed to serve at the same time on a daily basis to serve the needs of a 40 lb dog. The pods 901 in the optional construction could be connected by an accordion 925 or similar folding method for efficient packaging.

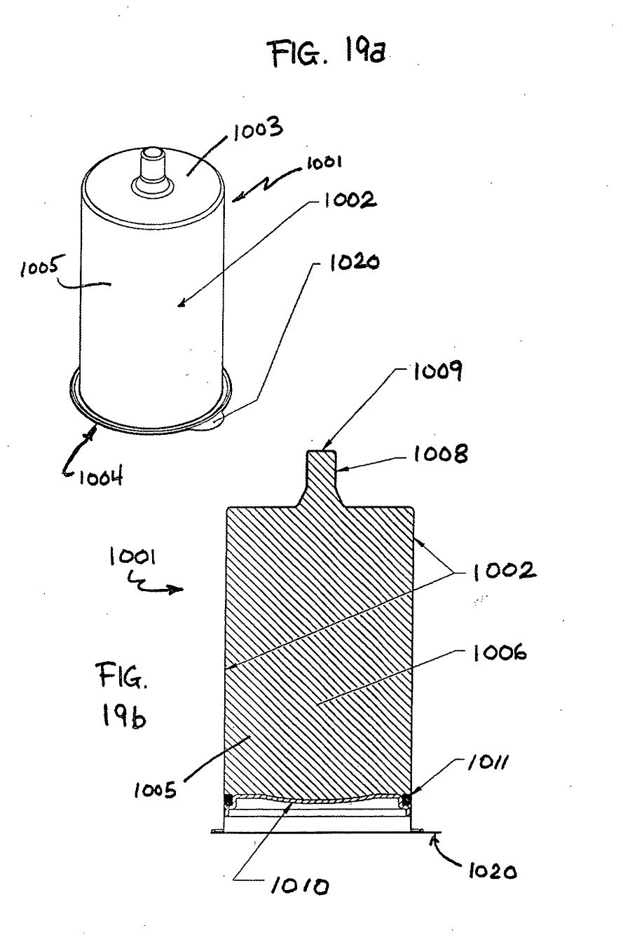

An alternate embodiment pod 1001, disclosed in FIGS. 19a and 19b, is a multi-piece construction with a single integrated nozzle. The pod side wall material can be made from epoxy coated aluminum alloy or any other similar material that is, to the extent necessary, FDA approved. The pod is intended to make a single serving. The pod includes a cylindrical side wall 1002 that is closed at either ends 1003 and 1004 to form an internal chamber 1005. The side wall 1002 is structurally reinforced by the appliance chamber wall during processing. The internal chamber 1005 includes a dry ingredient chamber 1006. Water is designed to be injected into the chamber 1005 by the appliance, allowing the water to flow into the dry ingredients. The pod 1001 includes a rigid pod nozzle 1008 that is sealed by a food burst disk 1009 that is designed to burst at extrusion pressure, allowing processed food to extrude through the nozzle, with its specially engineered geometry for low shearing and optimum expansion/texturing of the extruded food product. The pod 1001 further includes a sealed compression plate 1010, with o-ring seals 1011, that forces processed food material through the extrusion nozzle 1008 under appliance generated pressure. The user removes an adhesive-backed freshness seal 1020 prior to loading the pod 1001 into the appliance. The pod 1001 does not include an internal fat pouch, but rather, fat is sprayed onto the extruded food material by the appliance after exiting the nozzle 1008.

The pods shown in FIGS. 13 through 19 are all designed and sized as a home appliance for conveniently producing single and/or multiple servings of nutritious, freshly made food products for humans or pets. Food ingredients are purchased separately as a pre-formulated and pre-mixed batch that is hermetically sealed inside a pod of the type shown in FIGS. 13 through 19, constructed of food grade material which has an integrated extrusion nozzle. In pet food application, pods are formulated and sized according to specific daily nutrition requirements of end use animals, which is beneficial to portion control and weight management.

Each batch ingredient has a moisture percentage that is low enough to prevent bacterial growth and rancidity during pod storage. Optionally, the ingredient batch can be:
a) Hermetically sealed within a nitrogen environment (preferred embodiment); or
b) Sterilized through a retort process.

If the finished food product requires fat for nutritional value:
a) Fat is stored in a separate, replaceable appliance reservoir outside of the pod and is spray dispensed onto the finished food product as it exits from the pod nozzle. Flavorings and seasonings can be dispensed in the same manner (preferred embodiment); or
b) A separate pouch containing the required measurement of fat is included inside the pod, with the fat being dispensed into the finished food product as that product exits from the pod nozzle. Flavorings and seasonings can be dispensed in the same manner.

Individual pods may have an attached bar code containing process parameters (mix time, pressure, temperature, extrusion velocity, cutter speed, etc.) unique to the intended finished food product. The code is read by the appliance's control system at the beginning of the process, as more fully described herein below.

The following is a generic description of the process. Process parameters would be adjusted depending on food ingredients:
1. A food pod is loaded into the appliance's process chamber, the chamber door is closed and the start button is pushed. From that point, the rest of the process is automatically controlled via microprocessor.
2. Water is introduced to the premixed dry ingredients within the pod by:
   a) Mechanically applying pressure to burst the seal of a dedicated channel that connects a water blister within the pod to the main volume of the pod, allowing required water to flow into the dry ingredients (preferred embodiment).
   b) Mechanically piercing the seal of a dedicated channel that connects a water blister within the pod to the main volume of the pod, allowing required water to flow into the dry ingredients.
   c) Pumping required water from a refillable reservoir within the appliance and injecting that water through the pod wall and into the dry ingredients.
3. The dry ingredients and water within the pod are mixed by:
   a) A combination of timed vibration at controlled frequencies and mechanical manipulation of the pod contents (preferred embodiment).
   b) Heating the pod to the ambient boiling point of its contained water. The water would mix with the dry ingredients via steam migration.
4. The pod is pressurized to a defined process pressure between 50 psi and 400 psi while heated until the food material reaches a defined temperature between 140° C. and 150° C. (approximately eight minutes). At that temperature, the pod pressure is increased to a defined extrusion pressure between 300 psi and 500 psi at which the pod nozzle is opened.
5. As the extrusion pressure is maintained, the food material is driven through the pod nozzle in a continuous flow where it expands upon exit and is cut into equal segments.
6. Once the process is complete, the spent pod is simply removed from the chamber and discarded. The process can also be started with an integral timer. The user would load a pod into the process chamber and set the desired start time.

Process and extrusion pressures are generated and maintained by decreasing/increasing the closed volume of the process chamber in which the pod is placed. This can be accomplished with:
a) a steam/relief valve combination (preferred embodiment);
b) a piston/lead-screw/reversible motor combination;
c) a piston/lead-screw/reversible motor/non-compressible high temperature fluid combination; or
d) a thermally expandable fluid/relief valve combination.

Process and extrusion pressures are confirmed by:
a) timeout acquired from test data (preferred embodiment); or
b) feedback from a pressure transducer.

Process heat is generated with:
a) steam (preferred embodiment); or
b) electric heater(s).

Process temperatures are confirmed by:
a) timeout acquired from test data (preferred embodiment); or
b) feedback from thermocouples placed at specific locations within the process chamber.

The pod nozzle opens when:
a) a clamp, integral to the appliance and pinching the nozzle closed, is opened. Under the extrusion pressure, the flexible pod nozzle forms to specially engineered geometry within the appliance for optimum expansion and texture of the food product (preferred embodiment); or
b) the thin edge of an integrated burst disk shears due to the force generated from the extrusion pressure being applied to the disk area. A small, thicker segment of the disk edge does not shear and acts as a hinge, keeping the sheared disk attached to the nozzle as the food material exits. The rigid pod nozzle includes specially engineered geometry for optimum expansion and texture of the food product.

The discharging/expanding food material is cut by:
a) a series of rotating blades. Segment length is set by adjustment of blade rotation speed, and is monitored via current feedback from the blade motor. (preferred embodiment); or
b) Reciprocating star-burst disk integral to the (rigid) pod nozzle, activated by pulsed extrusion pressure.

Food expansion occurs as a result of flashing (instant boiling) of most of the water content within the food material upon exposure to atmospheric pressure outside of the pod nozzle. Expansion rate and final moisture content are controlled by regulation of the initial moisture and starch percentages of the pre-formulated ingredient batch within the pod.

The invention can be used for producing a variety of freshly made and nutritiously balanced foods including but not limited to:
Breakfast Cereals
Snack Foods
Pet Foods
Pastas
Croutons

Each food type has unique characteristics in palatability, texture and density which result from pressure and temperature being specifically applied to its original moisture and starch contents during a specified cooking time. Moisture and starch contents vary from food type to food type. *Thus, required pressure and temperature values vary as well, but are within the ranges shown in the following process methods. The food's flavor is primarily determined by the base ingredients of the food recipe. Each food type can be produced by one or either of two processing methods, described below.

### Method 1 (Approximately 8 Minutes)

1. Food pod is loaded into the process chamber.
   Required process parameters are sent to the appliance's on-board controller via bar code on food pod.
2. Start button is pushed.
3. Food pod is pressurized via piston to required cooking pressure (approximately 10 seconds).
   Food material is cooked as food pod temperature is ramped via conductive heaters to required extrusion temperature (approximately 8 minutes). Cooking pressure is maintained constant.
4. Once food material attains required extrusion temperature, food pod cooking pressure is elevated to required extrusion pressure (approximately 10 seconds).
5. Extrusion pressure activates opening of food pod nozzle and pressurized food material is extruded through the nozzle as extrusion pressure is maintained constant. Food material expands as it exits the nozzle and is cut into desired segments by a series of rotating blades. Segment length is controlled with blade speed. Segment shape (cross section) is controlled with nozzle geometry.
6. Process ends when all food material has exited the food pod.

### Parameters

(Ranges shown accommodate processing of various food types)
Cooking Pressure Range: 40 psi to 400 psi
Extrusion Temperature Range: 120° C. to 220° C.
Extrusion Pressure Range: 300 psi to 500 psi

### Method 2 (Approximately 8 Minutes)

1. Food pod is loaded into the process chamber.
   Required process parameters are sent to the appliance's on-board controller via bar code on food pod.
2. Start button is pushed.
3. Food pod is pressurized via piston to required dwell pressure (approximately 10 seconds). Food material is partially cooked as food pod temperature is ramped via conductive heaters to a dwell temperature that is slightly below the finished cooking temperature of the food material. Temperature is dwelled for approximately 6 minutes while dwell pressure is maintained constant.
4. Food material is fully cooked as dwell temperature is ramped to required extrusion temperature (approximately 2 minutes).
5. Once food material attains required extrusion temperature, food pod dwell pressure is elevated to required extrusion pressure (approximately 10 seconds).
6. Extrusion pressure activates opening of food pod nozzle and pressurized food material is extruded through the nozzle as extrusion pressure is maintained constant. Food material expands as it exits the nozzle and is cut into desired segments by a series of rotating blades. Segment length is controlled with blade speed. Segment shape (cross section) is controlled with nozzle geometry.
7. Process ends when all food material has exited the food pod.

### Parameters

(Ranges shown accommodate processing of various food types)
Dwell Pressure Range: 40 psi to 400 psi
Dwell Temperature Range: 100° C. to 180° C.
Extrusion Temperature Range: 120° C. to 220° C.
Extrusion Pressure Range: 300 psi to 500 psi

Having described certain embodiments of the invention, it will be apparent to those of ordinary skill in the art that other embodiments incorporating the concepts disclosed herein can be used without departing from the spirit and the scope of the invention. Accordingly, the described embodiments are to be considered in all respects only as illustrative and not restrictive.

1. A combination of a counter-top, low shear food cooker/extruder apparatus and a pod, used together for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein:
said apparatus comprises a compression module for receiving said pod;
said pod contains a chamber for storage and processing of the dry ingredients used in preparing the desired food product; and
said compression module includes:
means for introducing water into the dry ingredients within said chamber in said pod;
means for mixing the dry ingredients and water within said chamber in said pod to form the food product;
means for applying process parameters of pressure and temperature to the food product in said chamber in said pod, as opposed to such parameters being produced by the food product, making the process highly efficient in ingredient consumption, cost, nutrient provision, control and repeatability; and
means for expelling the food product from said pod and from said compression module.

2. A combination of a counter-top, low shear food cooker/extruder apparatus and a pod, used together for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein:
said apparatus comprises a compression module for receiving said pod;
said pod contains a chamber for storage and processing of the dry ingredients used in preparing the desired food product;
said compression module includes:
means for introducing water into the dry ingredients within said chamber in said pod; and
means for mixing and heating the dry ingredients and water within said chamber in said pod to form the food product; and
said compression module further includes means for expelling the food product from said pod and from said compression module.

3. A combination of a cooker and extruder apparatus for the customized production of food products and a pod containing ingredients that are processed in said pod when said pod is placed into said apparatus while said apparatus is sitting on a countertop or in a pet feeding area within the home, wherein:
said apparatus comprises:
compression module means for subjecting the ingredients within said pod to low shear thermo-mechanical processing, including:
a process chamber into which said pod containing the ingredients is inserted;
means for introducing water into the ingredients within said pod;
means for mixing the ingredients and water within said pod to form a food product;
means for heating the food product within said pod; and
means for expelling the food product from said pod;
dryer module means for drying the expelled food product; and
control means for controlling operation of said compression module means and said dryer module means; and
said pod comprises:
means for storing the ingredients within said pod;
means for containing the ingredients and water within said pod during mixing and heating of the ingredients and water to form the food product; and
means for extracting the food product from said pod in preparation for expulsion from said compression module of said apparatus.

4. A combination of a cooker and extruder apparatus and a pod for the customized, low shear thermo-mechanical processed production of food products from dry ingredients that are contained and processed within said pod when said pod is placed into said apparatus while said apparatus is sitting on a countertop or in a pet feeding area within the home, wherein:
said pod comprises a chamber containing the dry ingredients and extrusion means;
said apparatus comprises;
a compression module into which said pod containing the dry ingredients is inserted, said compression module includes: means for introducing water into the dry ingredients; mixing means for mixing the dry ingredients and water within said chamber to form the food product; heating means for heating the food product within said chamber; and means for expelling the food product from said chamber through said extrusion means; and
wherein said extrusion means comprises a pressure-actuated trigger means and an extrusion nozzle connected to said chamber when a pre-determined pressure is reached within said chamber.

5. The combination of claim 4, wherein said compression module is formed within a cylinder having a diameter from about 0.25″ to about 4″ and means for expelling comprises piston means with a stroke of from about 0.5″ to about 18″.

6. The combination of claim 5, wherein said piston means includes an annular piston the use of which vastly increases the heat transfer area since heating can be achieved both inside and outside the annulus, with a dramatic decrease in cycle time and improvement in product uniformity.

7. The combination of claim 6 wherein said heating means is an external means of heating, such as conduction heating, thereby eliminating shear such as would normally occur earlier in the process in a standard screw extruder and causing shear to only occur when the product enters the extrusion means when an inherently high-shear operation required to create the desired product characteristics occurs.

8. The combination of claim 7, said apparatus further comprising a dryer module including knife means for cutting the ingredients extruded through said extrusion means into desired lengths; and
a control unit for controlling operation of said compression module and said dryer module.

9. The apparatus of claim 5, wherein said piston means includes a rotating mechanism to introduce a minimum amount of shear as may be necessary to aid the cooking of the food product, but not enough to damage the food product.

10. The apparatus of claim 9, wherein the heating can be performed under pressure as high as 500 psi.

11. The apparatus of claim 10, wherein a variety of dies or nozzles can be used with the extruder to produce different finished products and to accommodate different viscosity food products.

12. A combination of a counter-top, low shear food cooker/extruder apparatus and a pod, used together for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein:
said pod contains a chamber for storage and processing of the dry ingredients used in preparing the desired food product;
said apparatus comprises:
a compression module including a chamber for inserting therein said pod carrying the raw food materials and for processing therein the food materials within said pod, a quick-release sealed chamber cover for maintaining high pressure in said chamber during the cooking/extrusion process, a heating element that surrounds said chamber, a variable speed piston for ejecting processed food materials from said pod, a piston drive mechanism, and an adjustable pressure-activated nozzle for controlling the expansion rate of food materials ejected from said pod;
a dryer module including a variable speed blade for cutting extruded/expanded food material to desired lengths, a bin for capturing and containing said food material, a heater for drying and toasting said food material, a blower for circulating said food material during the drying/toasting process, and an enclosure that houses the blade, bin, heater and blower; and
a control unit including an electro/mechanical hardware and circuitry, which controls all electrical, mechanical, and physical aspects of the cooking, extrusion, drying and toasting processes.

13. The piston drive mechanism of claim 12, wherein said piston drive mechanism is mechanically (e.g., a screw), electrically, hydraulically, or pneumatically driven.

14. A method of producing food products comprising the steps of:
inserting and storing food materials of a particular recipe in a chamber of a pod;
sealing said chamber of said pod;
inserting said pod into a compression module of a cooking and extruding apparatus to produce food product from the food materials;
sealing and locking said pod within said compression module;
introducing water into the food materials;
mixing the food materials and water;
activating a heating element to begin the process of cooking the food materials;
raising the pressure and boiling point of the food materials continuously above their atmospheric levels to thereby transform the starches within the food material to a plasticized state;
after a specified elapsed cooking time dependant on recipe and ingredient quantities of the food material, deactivating said heating element to terminate the cooking process;
extruding the food material from said pod by decreasing the volume of said chamber and, thereby, further increasing the differential pressure between the food materials within said chamber and atmospheric pressure outside of said chamber;
once the pressure of the food materials within said chamber reaches a pre-determined level, opening a nozzle or valve and allowing the pressurized food material to flow from said chamber through said nozzle or valve;
continuing to extrude the food material until all food materials within said chamber have been ejected from said chamber; and
causing approximately ninety five percent of the water content within the food material to instantaneously boil upon exiting from said chamber through said nozzle or valve, thereby causing the ejected food material to expand, with the expansion rate being dependent upon original water content of the recipe and controlled by multiple mechanical parameters such as nozzle orifice size and piston speed; and
causing the plasticized starches throughout the food material to go through a glass transition, that is, to form cellular structures that cool rapidly to maintain the size, shape and texture of the expanded food product.

15. The method of claim 14, further comprising the steps of:
introducing the expanded food product flowing from said compression module nozzle into a dryer module through an opening in the enclosure wall of said dryer module; and
cutting the food product into equal length sections by a spinning blade as the food material enters the drying module, based on the desired size and/or shape of the finished food product.

16. The method of claim 15, further comprising the steps of:
causing the cut food product to be gravity fed into a perforated holding bin; and
once the complete batch of food product has been sectioned and is in the holding bin, activating a heater and a blower unit to toast the food product for added flavor and decrease its moisture content to, for example, between about three percent and about five percent.

17. The method of claim 16, wherein the heater is located directly beneath the holding bin and has an output of approximately 400 watts and further comprising the step of:
toggling on and off the heater by a thermostat control until the desired resultant moisture content is achieved, dependent on the food product being produced.

18. The method of claim 16, wherein the blower unit is located directly beneath the heater, has an output of approximately 20 cfm, and further comprising the steps of continuously running the blower throughout the drying/toasting process to promote even heating and to prevent burning of the food product by circulating the food sections within the bin during the drying/toasting process.

19. The method of claim 16, further comprising the steps of sweetening, flavoring, coloring, texturizing, enriching, and/or otherwise treating the finished food product.

20. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises:
a first chamber for storage and processing of the dry ingredients;
means for introducing water into said first chamber so that the dry ingredients and water can be mixed together to form a food product;
means for mixing the dry ingredients and the water to form the food product; and
means for extruding the food product from said pod.

21. The pod of claim 20, wherein said water introducing means comprises a second water blister chamber within said first chamber, which second chamber is mechanically burst or pierced, allowing water from said second chamber to flow into said first chamber and be mixed together with the dry ingredients to form the food product.

22. The pod of claim 20, wherein said water introducing means comprises a reservoir outside said pod and said pod includes means for injecting the water from said outside reservoir into said first chamber for mixing the water together with the dry ingredients to form the food product.

23. The pod of claim 20, wherein said means for mixing comprises means for subjecting the dry ingredients and water to a combination of timed vibration at controlled frequencies and mechanical manipulation.

24. The pod of claim 20, wherein said means for mixing comprises means for subjecting the water in said first chamber to heating to cause resultant steam migration into the dry ingredients.

25. The pod of claim 20, wherein said means for extruding the food product from said pod comprises a pod nozzle and means for pressurizing and heating the food product in said first chamber and means for opening the pod nozzle to cause the food product to be extruded out the nozzle and to expand as a result of flashing of most of the water content within the food product upon exposure to atmospheric pressure outside of said pod nozzle.

26. The pod of claim 20, wherein said pod further includes means for adding fat, flavorings or seasonings to the food product as it is extruded for nutritional value or if the food product requires flavorings or seasonings.

27. The pod of claim 26, wherein said adding means comprises a third reservoir within said first chamber, and said pod further includes means for sealing said third reservoir and for opening said third reservoir to dispense its contents on the food product as the food product is extruded from said pod.

28. The pod of claim 26, wherein said adding means comprises a third reservoir outside of said first chamber, and said pod further includes means for sealing said third reservoir and for opening said third reservoir to dispense its contents on the food product as the food product is extruded from said pod.

29. The pod of claim 20, wherein said pod further includes bar code means that contains processing parameters unique to the intended finished food product in said pod and said bar code means is read by the cooker/extruder apparatus at the beginning of the process in order to convey the requisite processing parameters to the cooker/extruder apparatus.

30. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises:
a first chamber for storage and processing of the dry ingredients;
means for introducing water into said first chamber so that the dry ingredients and water can be mixed together to form a food product;
means for mixing the dry ingredients and the water to form the food product; and
means for extruding the food product from said pod;
wherein said water introducing means comprises a second water blister chamber within said first chamber, which second chamber is mechanically burst or pierced, allowing water from said second chamber to flow into said first chamber and be mixed together with the dry ingredients to form the food product; and
wherein said means for mixing comprises means for subjecting the dry ingredients and water to a combination of timed vibration at controlled frequencies and mechanical manipulation.

31. The pod of claim 30, wherein said means for extruding the food product from said pod comprises a pod nozzle and means for pressurizing and heating the food product in said first chamber and means for opening the pod nozzle to cause the food product to be extruded out the nozzle and to expand as a result of flashing of most of the water content within the food product upon exposure to atmospheric pressure outside of said pod nozzle.

32. The pod of claim 30, wherein said pod further includes means for adding fat, flavorings or seasonings to the food product as it is extruded for nutritional value or if the food product requires flavorings or seasonings.

33. The pod of claim 32, wherein said adding means comprises a third reservoir within said first chamber, and said pod further includes means for sealing said third reservoir and for opening said third reservoir to dispense its contents on the food product as the food product is extruded from said pod.

34. The pod of claim 30, wherein said pod further includes bar code means that contains processing parameters unique to the intended finished food product in said pod and said bar code means is read by the cooker/extruder apparatus at the beginning of the process in order to convey the requisite processing parameters to the cooker/extruder apparatus.

35. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises:
a first chamber for storage and processing of the dry ingredients;
means for introducing water into said first chamber so that the dry ingredients and water can be mixed together to form a food product;
means for mixing the dry ingredients and the water to form the food product; and
means for extruding the food product from said pod;
wherein said water introducing means comprises a reservoir outside said pod and said pod includes means for injecting the water from said outside reservoir into said first chamber for mixing the water together with the dry ingredients to form the food product; and
wherein said means for mixing comprises means for subjecting the dry ingredients and water to a combination of timed vibration at controlled frequencies and mechanical manipulation.

36. The pod of claim 35, wherein said means for extruding the food product from said pod comprises a pod nozzle and means for pressurizing and heating the food product in said first chamber and means for opening the pod nozzle to cause the food product to be extruded out the nozzle and to expand as a result of flashing of most of the water content within the food product upon exposure to atmospheric pressure outside of said pod nozzle.

37. The pod of claim 35, wherein said pod further includes means for adding fat, flavorings or seasonings to the food product as it is extruded for nutritional value or if the food product requires flavorings or seasonings.

38. The pod of claim 37, wherein said adding means comprises a third reservoir within said first chamber, and said pod further includes means for sealing said third reservoir and for opening said third reservoir to dispense its contents on the food product as the food product is extruded from said pod.

39. The pod of claim 35, wherein said pod further includes bar code means that contains processing parameters unique to the intended finished food product in said pod and said bar code means is read by the cooker/extruder apparatus at the beginning of the process in order to convey the requisite processing parameters to the cooker/extruder apparatus.

40. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises:
a first chamber for storage and processing of the dry ingredients;
means for introducing water into said first chamber so that the dry ingredients and water can be mixed together to form a food product;
means for mixing the dry ingredients and the water to form the food product; and
means for extruding the food product from said pod;
wherein said water introducing means comprises a second water blister chamber within said first chamber, which second chamber is mechanically burst or pierced, allowing water from said second chamber to flow into said first chamber and be mixed together with the dry ingredients to form the food product; and
wherein said means for mixing comprises means for subjecting the water in said first chamber to heating to cause resultant steam migration into the dry ingredients.

41. The pod of claim 40, wherein said means for extruding the food product from said pod comprises a pod nozzle and means for pressurizing and heating the food product in said first chamber and means for opening the pod nozzle to cause the food product to be extruded out the nozzle and to expand as a result of flashing of most of the water content within the food product upon exposure to atmospheric pressure outside of said pod nozzle.

42. The pod of claim 40, wherein said pod further includes means for adding fat, flavorings or seasonings to the food product as it is extruded for nutritional value or if the food product requires flavorings or seasonings.

43. The pod of claim 42, wherein said adding means comprises a third reservoir within said first chamber, and said pod further includes means for sealing said third reservoir and for opening said third reservoir to dispense its contents on the food product as the food product is extruded from said pod.

44. The pod of claim 40, wherein said pod further includes bar code means that contains processing parameters unique to the intended finished food product in said pod and said bar code means is read by the cooker/extruder apparatus at the beginning of the process in order to convey the requisite processing parameters to the cooker/extruder apparatus.

45. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises:
a first chamber for storage and processing of the dry ingredients;
means for introducing water into said first chamber so that the dry ingredients and water can be mixed together to form a food product;
means for mixing the dry ingredients and the water to form the food product; and
means for extruding the food product from said pod;
wherein said water introducing means comprises a reservoir outside said pod and said pod includes means for injecting the water from said outside reservoir into said first chamber for mixing the water together with the dry ingredients to form the food product; and
wherein said means for mixing comprises means for subjecting the water in said first chamber to heating to cause resultant steam migration into the dry ingredients.

46. The pod of claim 45, wherein said means for extruding the food product from said pod comprises a pod nozzle and means for pressurizing and heating the food product in said first chamber and means for opening the pod nozzle to cause the food product to be extruded out the nozzle and to expand as a result of flashing of most of the water content within the food product upon exposure to atmospheric pressure outside of said pod nozzle.

47. The pod of claim 45, wherein said pod further includes means for adding fat, flavorings or seasonings to the food product as it is extruded for nutritional value or if the food product requires flavorings or seasonings.

48. The pod of claim 47, wherein said adding means comprises a third reservoir within said first chamber, and said pod further includes means for sealing said third reservoir and for opening said third reservoir to dispense its contents on the food product as the food product is extruded from said pod.

49. The pod of claim 45, wherein said pod further includes bar code means that contains processing parameters unique to the intended finished food product in said pod and said bar code means is read by the cooker/extruder apparatus at the beginning of the process in order to convey the requisite processing parameters to the cooker/extruder apparatus.

50. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises:
a first chamber for storing and processing the dry ingredients;
means for introducing water into the first chamber;
means for processing the dry ingredients and water in said first chamber to form food material;
an integrated nozzle;
means for extruding the food material through said nozzle; and
cutting blades integrated within said nozzle, making cleaning of the apparatus optional but unnecessary.

51. More than one disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein:
each said disposable pod comprises:
a first chamber for storing and processing the dry ingredients;
means for introducing water into the first chamber;
means for processing the dry ingredients and water in said first chamber to form food material;
an integrated nozzle; and
means for extruding the food material through said nozzle; and
said pods are connected together by folding means, and said pods can be run in succession through the apparatus.

52. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises a multi-piece construction having an internal water blister and an integrated flexible extrusion nozzle.

53. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein:
said pod comprises a multi-piece, single serving construction;
said pod includes upper and lower side walls constructed from flexible thermoplastic material or flexible aluminum composite foil, or any other similar material that is, to the extent necessary, FDA approved;
said pod further including heat seams that seam together said upper side wall and said lower side wall, an internal chamber formed by said side walls, said internal chamber including a dry ingredient pouch and a water blister that is designed to burst at specific process pressure, allowing water to flow from said water blister into said dry ingredient pouch; and
said pod further including a flexible nozzle and seams at both ends of said pod nozzle to keep pre-processed food and foreign matter out of said nozzle.

54. The pod of claim 53, said pod further including a chamber clamp, said clamp including upper and lower members that hold said pod nozzle closed to keep the food material from exiting during processing; wherein at extrusion pressure said clamp opens, said nozzle seams burst and food is extruded through said pod nozzle; said flexible pod nozzle conforming to the specially engineered geometry of an exit channel in said apparatus, the geometry of said exit channel promoting the low shearing and optimum expansion/texture of the extruding food product.

55. The pod of claim 54, said pod further including alignment holes which are used to position the pod within said apparatus.

56. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises a multi-piece construction having an internal water pouch, an internal fat pouch and an integrated rigid extrusion nozzle.

57. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein:
said pod comprises a multi-piece single serving construction;
said pod includes a cylindrical side wall constructed from rigid and flexible thermoplastic material or aluminum alloy, or any other similar material that is, to the extent necessary, FDA approved, that is closed at either ends to form an internal chamber, wherein said side wall is structurally reinforced by the apparatus chamber wall during processing;
said internal chamber includes a dry ingredient chamber and a water pouch that is designed to burst at a specific pressure, allowing the water to flow from said water pouch into the dry ingredients in said dry ingredients chamber;
said pod further includes a rigid pod nozzle that is sealed by a food burst disk that is designed to burst at extrusion pressure, allowing processed food to extrude through said nozzle with its specially engineered geometry for low shearing and optimum expansion/texturing of the extruded food product;
said pod further includes a sealed compression plate that forces processed food material through said extrusion nozzle under apparatus generated pressure;
said pod further includes an internal fat pouch sealed by a fat burst ring and fat discharge channels, wherein said fat burst ring is designed to burst at extrusion pressure, allowing fat to flow from said fat pouch through said fat discharge channels to dispense onto the extruding food material, wherein the force of said compression plate on the food material within said chamber applies force to said fat pouch and forces the fat out said fat discharge channels.

58. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises a multi-piece construction having an annular ring chamber in which is stored a single supply of dry food ingredients, a single water pouch, multiple fat pouches and multiple extrusion nozzles.

59. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein:
said pod comprises a multi-piece construction
said pod includes a cylindrical side wall and an internal wall, constructed from rigid and flexible thermoplastic material or aluminum alloy, or any other similar material that is, to the extent necessary, FDA approved, an annular closure at one end and a full closure at the other end to form an annular internal chamber, wherein said side wall is structurally reinforced by the apparatus chamber wall during processing and said internal wall is structurally reinforced by the internal heater shell of the apparatus during processing;
said internal chamber includes an annular dry ingredient chamber and a water pouch within said annular chamber designed to burst at a specific pressure, allowing the water to flow into the dry ingredients;
said pod further includes multiple rigid pod nozzles that are sealed by food burst disks designed to burst at extrusion pressure, allowing processed food to simultaneously extrude through said nozzles with their specially engineered geometry for low shearing and optimum expansion/texturing of the extruded food product;
said pod further including a compression plate, sealed with 0-rings, that forces processed food material through said extrusion nozzles 608 under appliance generated pressure;
said pod further including internal fat pouches, each sealed by a fat burst ring, and fat discharge channels, said fat burst rings being designed to burst at extrusion pressure, allowing fat to flow through said fat discharge channels and dispense onto the extruding food material, wherein the force of said compression plate on the food material within said annular chamber applies force to said fat pouches and forces the fat out of said fat pouches and through said discharge channels.

60. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises a multi-piece construction with a single supply of dry food ingredients in an annular ring chamber, means for introducing water into said annular ring chamber during processing, an integrated extrusion nozzle, and a compression plate for forcing processed food material through the extrusion nozzle.

61. The pod of claim 60, wherein said means for introducing water comprises means for injecting water into said annular ring chamber from an external reservoir in the apparatus.

62. The pod of claim 60, wherein said means for introducing water comprises first and second sealed compression plates in said annular ring chamber, between which water is stored for later mixing with the dry ingredients in sais annular ring chamber.

63. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein:
said pod comprises a multi-piece construction;
said pod includes a cylindrical side wall and an internal wall, constructed from rigid or semi-rigid thermoplastic material, or any other similar material that is, to the extent necessary, FDA approved, an annular closure at one end and a full closure at the other end to form an annular internal chamber, wherein said side wall is structurally reinforced by the apparatus chamber wall during processing and said internal wall is structurally reinforced by the internal heater shell of the apparatus during processing;
said internal chamber includes an annular dry ingredient ring chamber;
said pod includes means for introducing water into said annular ring chamber during processing;
said pod includes a rigid pod nozzle that is sealed by a food burst disk that is designed to burst at extrusion pressure, allowing processed food to extrude through said nozzle with its specially engineered geometry for low shearing and optimum expansion/texturing of the extruded food product;
said pod further including a compression plate that is sealed with 0-rings, wherein said compression plate forces processed food material through the extrusion nozzle under apparatus generated pressure; and
said pod further includes an adhesive-backed freshness seal which is removed by the user prior to loading said pod into the apparatus.

64. The pod of claim 63, wherein said means for introducing water comprises means for injecting water into said annular ring chamber from an external reservoir in the apparatus.

65. The pod of claim 63, wherein said means for introducing water comprises first and second sealed compression plates in said annular ring chamber, between which water is stored for later mixing with the dry ingredients in sail annular ring chamber.

66. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises a multi-piece construction with a flexible side wall, separate dry food ingredient and water pouches and an integrated extrusion nozzle.

67. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein:
said pod comprises a multi-piece single serving construction;
said pod includes an upper side wall and a lower side wall, constructed from flexible thermoplastic material or flexible aluminum composite foil, or any other similar material that is, to the extent necessary, FDA approved;
said pod includes heat seal seaming means for sealing said upper and lower side walls together to form a first internal chamber and a second internal chamber;
said first internal chamber includes a dry ingredient pouch or blister;
said second internal chamber includes a second water pouch or blister;
said pod further includes means for separating said two pouches or blisters prior to processing;
said pod further includes a rigid pod nozzle that is sealed by a food burst disk that is designed to burst at extrusion pressure, allowing processed food to extrude from said first internal chamber through said nozzle with its specially engineered geometry for low shearing and optimum expansion/texturing of the extruded food product.

68. The pod of claim 67, wherein said means for separating said two pouches or blisters prior to processing comprises a heat sealed seam, wherein said seam keeps the water and dry ingredients separated until a specific process pressure causes the seam to burst.

69. The pod of claim 67, wherein said means for separating said two pouches or blisters prior to processing comprises a clip, wherein said clip is removed by the user prior to loading the pod into the apparatus to allow the water and dry ingredients to mix.

70. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises a multi-piece construction with a semi-rigid side wall, separate dry food ingredient and water pouches and an integrated extrusion nozzle.

71. The pod of claim 70, wherein multiple said pods are connected and can be advanced through the apparatus for processing at different times.

72. At least two disposable pods for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein:
each said pod comprises a multi-piece single serve construction;
each said pod includes an upper side wall and a lower side wall, constructed from semi-rigid thermoplastic material, or any other similar material that is, to the extent necessary, FDA approved;
each said pod includes heat seal seaming means for sealing said upper and lower side walls together to form a first internal chamber and a second internal chamber;
each said first internal chamber includes a dry ingredient pouch or blister;
each said second internal chamber includes a second water pouch or blister;
each said pod further includes means for separating said two pouches or blisters prior to processing;
each said pod further includes a rigid pod nozzle that is sealed by a food burst disk that is designed to burst at extrusion pressure, allowing processed food to extrude from said first internal chamber through said nozzle with its specially engineered geometry for low shearing and optimum expansion/texturing of the extruded food product; and
wherein said pods are connected together by connection means and include alignment holes that can interact with pins in the apparatus that engage the alignment holes to insure proper seating of said pods within the apparatus and advancement of said pods through the apparatus.

73. The pods of claim 72, wherein said connection means comprises an accordion or similar folding method for efficient packaging of said pods prior to use.

74. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein said pod comprises a multi-piece pod construction with a rigid side wall, a dry food ingredient chamber into which water is injected by the apparatus during processing, an extrusion nozzle and a compression plate for forcing processed food material through said extrusion nozzle.

75. A disposable pod for use with a counter-top, low shear food cooker/extruder apparatus for the customized, on demand, preservative-free production in the home of fresh, ready to eat foods such as breakfast cereals and similar food products, from dry ingredients tailored to particular taste and texture preferences, to avoid allergens and to achieve better overall output quality due to minimized starch damage within the final food product, and for the production in the home of pet food products, all at an economical cost per batch, wherein:
said pod comprises a multi-piece single serving construction;
said pod includes a cylindrical side wall, constructed from epoxy coated aluminum alloy, or any other similar material that is, to the extent necessary, FDA approved, which is closed at either ends to form an internal chamber; wherein said side wall is structurally reinforced by the apparatus chamber wall during processing;
said internal chamber includes a dry ingredient chamber;
said pod further including means for injecting water into said dry ingredient chamber so that the water can flow into the dry ingredients;
said pod further including a rigid pod nozzle that is sealed by a food burst disk that is designed to burst at extrusion pressure, allowing processed food to extrude through said nozzle with its specially engineered geometry for low shearing and optimum expansion/texturing of the extruded food product;
said pod further including a sealed compression plate, with o-ring seals, that forces processed food material through said extrusion nozzle under appliance generated pressure; and
said pod further including an adhesive-backed freshness seal which the user removes prior to loading said pod into the appliance.
